(19) United States
(12) Patent Application Publication
(10) Pub. No.: US 2007/0061567 A1
(43) Pub. Date: Mar. 15, 2007

(54) Digital information protection system

(76) Inventors: Glen Day, Santa Monica, CA (US); Julian Michailov, Toronto (CA); Craig Cluett, Toronto (CA); Don Ruiz, Toronto (CA)

Correspondence Address: CISLO & THOMAS, LLP, 233 WILSHIRE BLVD, SUITE 900, SANTA MONICA, CA, 90401-1211, US

(21) Appl. No.: 11/518,823

(22) Filed: Sep. 10, 2006

Related U.S. Application Data
(60) Provisional application No. 60/715,713, filed on Sep. 10, 2005.

(51) Int. Cl. H04L 9/00

(52) U.S. Cl. 713/159

(57) ABSTRACT

A system by which documents and other network resources may be kept secure and private. Using public key encryption technology, an integrated set of elements serve to provide security, encryption, and privacy for files, e-mail and other messages, and network resources. Digital certificates are obtained and held as well as being managed and manipulated in order to secure testing in order to secure privacy and prevent unauthorized access to such network resources, files, and messages. The generally difficult enrollment process is handled efficiently and generally transparently to the user so that the complex and sophisticated process for such management is made more readily available to the individual user such that privacy and securing of information becomes readily available even to the new user who is unfamiliar with computer processes.

### CROSS-REFERENCES TO RELATED APPLICATIONS

This patent application is related to and claims priority from U.S. Provisional Patent Application Ser. No. 60/715,713 filed Sep. 10, 2005 entitled DIGITAL INFORMATION PROTECTION SYSTEM which application is incorporated herein by this reference thereto.

### COPYRIGHT AUTHORIZATION

Portions of the disclosure of this patent document may contain material which is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever.

### BACKGROUND OF THE INVENTION

1. Field of the Invention

This invention relates to computer security and more particularly to the securement of digital information by the use of digital certificates.

2. Description of the Related Art

Whitfield Diffie and Martin Hellmann established public key cryptography in 1976. With the rise of more rapid information transmission means such as personal computers and the Internet, privacy has become an increasing concern due to the billions of messages and millions of files that are transferred each day, at a conservative estimate.

Many people are currently not familiar with public key cryptography but the basics are well established and generally well known in the art. While such public key cryptography is generally simple to use, there still remains the process of actually encrypting and decrypting the information as well as establishing secure links to ensure the privacy of information. Currently, it is somewhat of an arduous task to affect such privacy using public key or other cryptographic means.

With increased concern in privacy of communications, the obstacles to providing convenient and regular usable means for signing and encrypting data, email messages, and the like as well as protecting the same has become an important focus of additional research in the computer science.

### SUMMARY OF THE INVENTION

In view of the foregoing disadvantages inherent in the known types of data encryption and the application of data certificates now present in the prior art, the present invention provides means by which less knowledgeable users or users unfamiliar with cryptographic techniques can readily and easily avail themselves of personal and digital IDs, privacy certificates, and the like while at the same time being able to apply them almost immediately with respect to their computer and data activities.

The general purpose of the present invention, which is described subsequently in greater detail below, is to provide data integrity, signature, and encryption/decryption techniques readily available for those of whatever skill level with regards to operating computers having many advantages of similar methods known heretofore as well as many novel features that result in a new digital and other information protection system, which is not anticipated, rendered obvious, suggested, taught, or even implied by any of the prior art systems, either alone or in any combination thereof.

The present invention provides means by which files, messages, and access to resources are made available under secure conditions. E-mail and files are separately subject to encryption and privacy controls. Additionally, with the use of a USB or other physical/electrical/electronic identifier, network access or other access to resources can be allocated on a secure basis.

Overall, a privacy and security toolkit is developed that provides a strategic solution for enterprises. The toolkit includes four primary components:

1. The secure digital ID management utility as a simple-to-use user interface for obtaining and managing the users' personal digital ID.

2. The secure email utility is an a utility that automatically configures and associates the digital ID with Microsoft's Outlook/Outlook Express clients, including automatically adding users' public keys to the Contact List. Novell's Groupwise, IBM's Lotus Notes and Eudora email clients are also supported. The secure email utility enables easily sent and secured email messaging.

3. The secure file utility is an extension to Microsoft's Windows Explorer named “My Vault” which provides secure file and folder capabilities using a very simple user interface and based on AES encryption.

4. The secure hardware token system provides hardware tokens (e.g., USB or smart cards) to securely store users' digital IDs for mobility and to provide strong 2-factor authentication. The secure hardware token system may replace an operating system (such as Windows) password logon experience with a token and a simple PIN.

All components of the toolkit may use reliable and digital IDs, such as valid X.509-compliant digital IDs as the authenticating mechanism for encryption and digital signature validation delivered as a managed service through industry leading trusted companies VeriSign and GeoTrust. Other ID systems may be developed in the future and may foreseeably substitute for those IDs now known and/or as disclosed herein.

The digital information protection toolkit system (the “toolkit”) may be based on the following principles. The toolkit provides a strategic security solution via a single integrated framework for strong user authentication, strong data encryption, mechanism for secure communication with partners, and document integrity validation. The toolkit may be delivered as a managed service without hardware server requirements. Consequently, the toolkit can be adapted for a wide variety of platforms and applications due to its flexibility and adaptability for digital environments. Users are provided access to simple-to-use and easy-to-learn security tools. Administrators are provided an easily scalable and easily supported security solution. The solution is implemented in hours (or other relatively short period of time) across large enterprises. Users generally require little to no user training. Trust in and the security of the toolkit system is designed to be global and verifiable. The toolkit is generally based on digital IDs issued by and accountable to reliable certificate or security token entities, such as the Global Trust Networks of VeriSign and GeoTrust.

Table 1, below, indicates some of the relationships between components of the toolkit:

TABLE 1

| | Module | Function |
|---|---|---|
| TOOLKIT | Secure Digital ID | The user's personal digital ID |
| | Management Utility | enrollment |
| | | The user's personal digital ID |
| | | configuration and management |
| | | Password Management |
| | Secure Email Utility | Auto-Configuration of Outlook |
| | | Auto-Add to Contacts (address book) |
| | Secure File Utility | File & Folder Data Encryption |
| | Secure Hardware | Hardware Token (USB or smart card) |
| | Token System | to store digital IDs for mobility |
| | | and strong 2-factor authentication |
| | | May replace Window's password |
| | | logon experience with a token |
| | | and PIN |

In one embodiment, a method for protecting integrity and secrecy of digital information provides an ID interface for obtaining and managing a personal digital ID as well as providing an email utility interface having access to the personal digital ID. The email utility interface automatically configures and associates the personal digital ID with an email program. The email utility interface is adapted to receive a public key from a sender and associate the public key with a contact entry for the sender. The email utility interface is adapted to facilitate sending of email with a signature derived from the personal digital ID. The protection method herein also provides a secure file area interface based upon the personal digital ID wherein when a file is dragged and dropped into the secure file area interface, the file is encrypted with the personal digital ID to provide an encrypted file. Further, the protection method herein provides a hardware token system securely storing the personal digital ID to provide authentication. In coordinated fashion, the ID interface, the email utility interface, the secure file area interface, and the hardware token system secure digital information with the personal digital ID including emails and digital files.

In another embodiment, a method for protecting integrity and secrecy of digital information provides an ID interface for obtaining and managing a personal digital ID. The ID interface provides an enrollment procedure for obtaining the personal digital ID, storing the personal digital ID in a secure certificate store. The ID interface then makes the personal digital ID available to an email utility, a secure file area interface, and/or otherwise.

In another embodiment, a method for protecting integrity and secrecy of digital information provides an email utility interface having access to a personal digital ID. The email utility interface automatically configures and associates the personal digital ID with an email program. The email utility interface is adapted to receive a public key from a sender and associate the public key with a contact entry for the sender. The email utility interface is adapted to facilitate sending of email with a signature derived from the personal digital ID.

In another embodiment, a method for protecting integrity and secrecy of digital information provides a secure file area interface based upon the personal digital ID wherein when a file is dragged and dropped into the secure file area interface, the file is encrypted with the personal digital ID to provide an encrypted file.

In another embodiment, a method for protecting integrity and secrecy of digital information provides a hardware token system securely storing the personal digital ID to provide authentication.

Other embodiments of the present invention are set forth in more detail, below, as the disclosure set forth herein also provides additional embodiments of the present technology, invention, and/or system. The embodiments set forth above are made for purposes of example only and not of limitation.

### BRIEF DESCRIPTION OF THE DRAWINGS

FIG. 1 is a diagrammatic view of the file storage areas used for the secure file utilities operations as well as diagrammatic portrayal of the encryption and decryption techniques thereof.

FIG. 2 is a graphical depiction of file encryption according to the present system.

FIG. 3 is a diagrammatic representation of file decryption according to the present system.

FIG. 4 is a diagrammatic representation of file decryption of file using a personal digital idea.

FIG. 5 is a diagrammatic portrayal in overview of the secure mail utility disclosed hearing.

FIG. 6 is a diagrammatic portrayal in overview of the secure of the digital ID management utility set forth.

FIG. 7 is a screen shot of program initiation for the secure digital ID management is utility.

FIG. 8 is a screen shot of a <screen> in the personal digital ID enrollment process.

FIG. 9 is a screen shot of an information gathering screen that may be used in the enrolling process in the personal digital ID

FIG. 10 is a screen shot of the secure digital ID management utility showing the personal digital ID currently in use.

FIG. 11 is a screen shot of the secure digital management utility showing available digital ID on an exemplary computer.

FIG. 12 is screen shot of the secure digital management utility showing audit log for personal digital IDs on an exemplary computer.

FIG. 13 is a screen shot of a pass word access to the digital ID management utility.

FIG. 14 is a screen shot of a success message with respect to the password set in FIG. 13.

FIG. 15 is screen shot of a password administration screen similar to that of FIG. 13 with an availability of a “forgotten password” option.

FIG. 16 is screen of a decision screen with respect to confirming authorization of a system provider.

FIG. 17 is a screen shot of a password administration screen generally identical to that of FIG. 15 presented to the user in establishing authorization to use the present system.

FIG. 18 is a screen shot identical to that of FIG. 16 encountered by the user in establishing authorization for the present system.

FIG. 19 is a screen shot of an authorization key entry screen.

FIG. 20 is a screen shot of an update option of the present system.

FIG. 21 is a screen shot of < > for the user indicating that the system is checking for updates.

FIG. 22 is a screen shot indicating to the user that the system is up to date.

FIG. 23 is a screen shot indicating to the user that the updates are available with downloading and update option.

FIG. 24 is a screen shot of a confirmation screen of the user to initiate the installation of an update.

FIG. 25 is screen shot indicating the successful installation of an update in instruction for the user to reboot the computer.

FIG. 26 is a screen shot of an address book for those selection of a global address list based specifically organization.

FIG. 29 is a screen shot of a confirmation screen requesting confirmation of the user to publish a digital certificate to a global address list/GAL.

FIG. 28 is a screen shot of a success screen indicating the publication of the user digital certificate to the GAL.

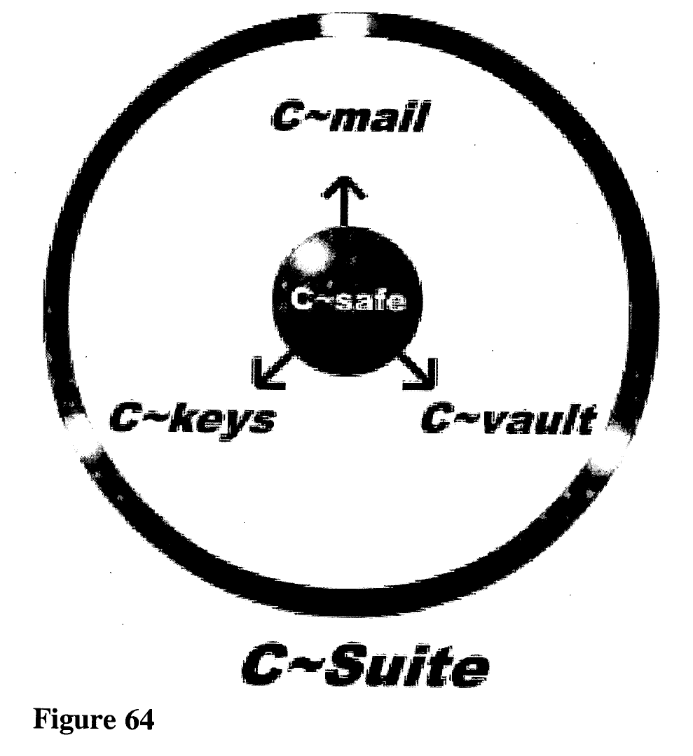

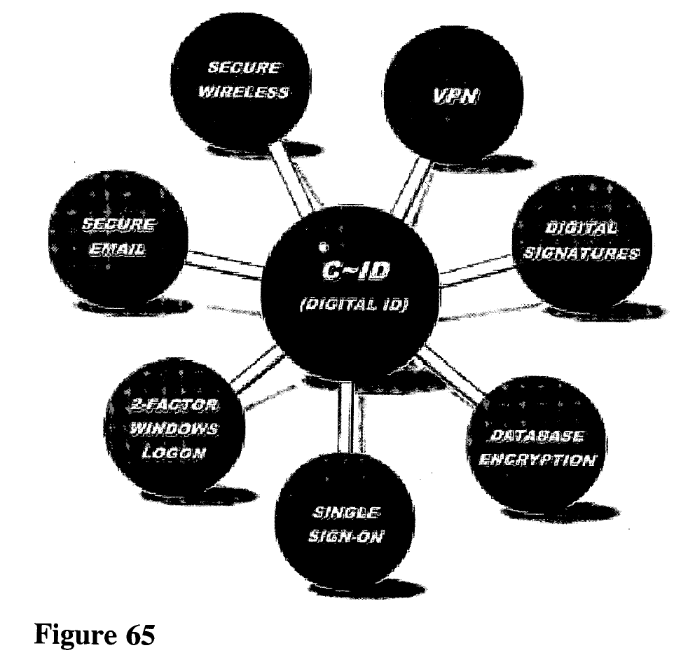

FIGS. 29 and 30 are screen shots of an email composition screen with FIG. 29 indicating the availability of signing the email with a personal digital ID as well as the availability with encrypting the email with a personal digital ID.

FIG. 31 portrays a drive grammatical transmission of a signed email for one individual to another.

FIG. 32 as screen shot of a received email listing with the encircled icon indicating the signed email.

FIG. 33 is an enlargement of the signature and encryption icons in the email program.

FIG. 34 is screen shot with an email composition screen with the encryption icon encircled.

FIG. 35 is diagrammatic depiction of encrypted email being transferred between two individuals as well as the personal IDs being added to their contact lists.

FIG. 36 shows the transmission of a signed portrays the transmission of signed email from one individual to another with the sender's personal digital ID or public key being transferred to the computer/contact list of the recipient.

FIG. 37 is diagrammatic portrayal of signed emails being transmitted by several individuals to a single individual with a public keys/personal digital IDs of the senders being automatic added to the recipient's contact database/computer.

FIG. 38 is screen shot of a contact's database listing indicating the present of a public key certificates/ID as indicated by the encircled indicia.

FIG. 39 is a screen shot of a certificate list of an individual contact.

FIG. 40 is a screen shot of a configuration screen showing an on/off switch for automatically updating and storing the contact information of incoming digital certificates with currently existing and yet to be received contact emails.

FIG. 41 is a screen shot of an email program indicating the actions need to access the email accounts control facility.

FIG. 42 is a screen shot of entries necessary for the user to view or change existing email accounts.

FIG. 43 is a screen shot of an email account editing control screen.

FIG. 44 is a screen shot of the selecting email accounting indicating the selected use of cashed exchange mode.

FIG. 45 is a screen shot of the email account control screen indicating means by which the user may exit the editing mode.

FIG. 46 is a screen shot of an open email with the selection of adding the sender to the user's contact database.

FIG. 47 is a screen shot of a directory listing of a secure file utility of the present invention.

FIG. 48 is a diagrammatic representation and screen shot of the secure file system of the present invention.

FIG. 49 is a screen shot of an operation to be performed on a file within the secure file system interfaced with the present invention.

FIG. 50 shows a diagrammatic screenshot of a file operation occurring in dragging and dropping a file into the secure file system interface of the present invention.

FIG. 51 is a screen shot of a message window showing the encryption or decryption of a file such as that is operated on in FIG. 50.

FIG. 52 is a screen shot showing the results of the moving of a file from the unencrypted area of a user's computer to an encrypted area within the secure file interface.

FIG. 53 is a screen shot of a secure file system interface and the option to create a new folder within that interface area.

FIG. 54 is a screen shot of the retrieval of an encrypted file in an application program.

FIG. 55 is a screen shot of a secure file interface as set forth herein showing through a <renaming> option of a file.

FIG. 56 is a screen shot of a secure file system interface showing the “delete” option.

FIG. 57 is a screen shot of a secure file system interface the present invention showing a “decrypted” email option for a selected file.

FIG. 58 is a screen shot of an email composition screen showing an attachment and a reminder to select the signs/encrypt icon to select the email securely.

FIG. 59 is a screen shot of the deleted item section of the secure file system interface of the present invention showing the “restore selected item” option.

FIG. 60 is a screen shot of the deleted item section of the secure file interface system set forth herein showing the delete option for the segregated item of the deleted item option.

FIG. 61 is a screen shot of the secure file interface of the present invention showing the option to log out from the secure file interface system.

FIG. 62 is a diagrammatic portrayal typical deployment architecture for the digital protected toolkit of the present invention.

FIG. 63 is a screen shot of the secure file system interface of the present invention showing the deleted items and the active file area icons.

FIG. 64 is a diagrammatic portrayal of the individual operating elements of the toolkit, including the digital ID management utility, the secure hardware token system, the secure file area interface system, and the secure email security.

FIG. 65 is a diagrammatic portrayal of a digital ID used in the present invention in conjunction with its various applications.

### BRIEF DESCRIPTION OF THE APPENDICES

The following appendices are incorporated herein by this reference thereto.

Appendices 1 and 2 are updated versions of end-user guides associated with the present invention.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

Certain trademarks are used in the drawing figures. As is know in the art, no dedication to the public domain nor use of such marks in the generic of descriptive sense is made by such use or otherwise herein.

The digital information protection toolkit system (the “toolkit”) of the present invention set forth herein provides overall management and deployment of a security system based on digital certificates. Using public key encryption technology (or otherwise with technologies now known or later developed), access to resources (networks, folders, printers, etc.), file storage and e-mail transmission and reception are all protected under an umbrella system that transparently handles encryption/decryption/data security with generally a minimal inconvenience to the user. As set forth herein, a user interface is provided that is generally intuitive. It allows easy comprehension of the steps involved. Certain tutorials may be involved for some users inexperienced with intelligent interfaces. As a result of the present system, greater deployment of public key encryption technology is available and provides for greater privacy and security with respect to sensitive or private documents.

Applications include the transmission or reception by secure means of medical records, legal documents, and the like. The present system also provides opportunities with respect to the digital signing of electronic documents so that parties may be bound with respect to the duties and responsibilities of contractual obligations or the like. Along these lines, doctors may issue prescriptions by electronic means that are secured to prevent forgery, particularly for scheduled classes of drugs and the like.

The present invention resides in a digital information protection toolkit having a variety of components that seeks to maintain the integrity of and/or security information in the forms of files, emails, and the like. Integrity is preserved by the use of personal digital IDs for signatures ensuring that the emails or files coming from a specific individual only. Further, such digital IDs may be used to encrypt the email or file so that only authorized individuals can acquaint themselves with the content of such encrypted emails and files.

Referring to the drawings, where the indicated indicia designate like elements throughout, the toolkit generally provides overall security for common desktop operations. There are generally four components of the toolkit. The secure file utility is an extension to MS (Microsoft) Windows Explorer and provides a very simple interface for users to secure their files. The secure email utility is an extension to MS Outlook and provides automated mechanisms to configure and operate Outlook allowing the user to easily secure their e-mail. Implementing these components requires the construction of three software entities. They are: the secure file utility (Windows Shell Layer); the secure email utility (Outlook Plug-in); and the secure digital ID management utility +the secure digital ID control utility (Windows™ Application).

Note should be taken that while mention is made of the Microsoft based operating system (Windows™) and Microsoft-based programs (e.g., Outlook™), such mention is made for exemplary purposes only and not those of limitation. The methods and solutions set forth herein are believed to be applicable to all other operating systems and relevant programs.

Table 2, below, shows the mapping between the product and component names, the function specified by each and the software entity that delivers the function.

TABLE 2

| User Term | | Software Implementation | |
|---|---|---|---|
| Product | Component | Function | Software Entity |
| TOOLKIT | The secure | File security | The secure file |
| | file utility | | utility (Windows |
| | | | Shell Layer) |
| | The secure | Automatic add | The secure email |
| | email utility | to contacts | utility (Outlook |
| | | | Plug-in) |
| | The secure | Configuration | The secure digital |
| | digital ID | of Outlook | ID management |
| | management | | utility (Windows |
| | utility | | Application) |
| | The secure | Enrollment | The secure digital |
| | digital ID | | ID management |
| | management | | utility |
| | utility | | configuration |
| | | | (Windows |
| | | | Application) |
| | The secure | The user's | The secure digital |
| | digital ID | personal digital ID | ID control utility |
| | control | configuration and | (Windows |
| | utility | management | Application) |
| | The secure | The secure digital ID | The secure digital |
| | digital ID | management utility | ID control utility |
| | control | configuration and | (Windows |
| | utility | management | Application) |

The aspects of the “Components” listed above are addressed generally in sequence below.

The secure file utility is an extension to MS Windows Explorer and provides a very simple interface for users to secure their files. The secure file utility is a Windows Shell Layer and hierarchically exists between the Windows Shell, seen by the user as Windows Explorer, and the Windows File System (NTFS and FAT). As files are manipulated in Windows Explorer, The secure file utility intercepts certain operations and modifies them to allow the user to secure files. The secure file utility creates an area on the users' hard drive called the Secured User Data or SUD. The SUD is not a particular physical location on the hard-drive but a logical grouping of encrypted files. The user may generally see the SUD as “My Vault” or otherwise from Windows Explorer. The secure file utility also allows the user to encrypt and decrypt individual files outside of My Vault.

All encrypted files, whether they are inside of My Vault or not, are encrypted using the configured the user's personal digital ID (X.509 Digital Certificate). They can only be decrypted by the secure file utility if the same the user's personal digital ID is configured. The user's personal digital IDs are stored in the Windows Certificate Storage Area. The encryption of a particular file is independent of all other encrypted files. This allows the user to manipulate files as always. One corrupted file only makes that file inaccessible and does not put at risk any other encrypted files. There are also no extra limitations on the size of My Vault for the user. My Vault is only limited by the normal limitations already found in Windows, such as overall hard disk space and limits imposed by hard disk partitioning. This method also allows files to be encrypted with different user's personal digital IDs allowing different users to “share” the same storage space. This does not allow users to share files as sharing files in this manner would also require the sharing of the user's personal digital IDs, a poor security practice. The intercepted operations are: “Save As” into My Vault; “Save” into My Vault; Open File and Launch Application from My Vault; Copy/Move into My Vault; Encrypt Outside of My Vault; Decrypt Outside of My Vault; and Copy/Move out of My Vault.

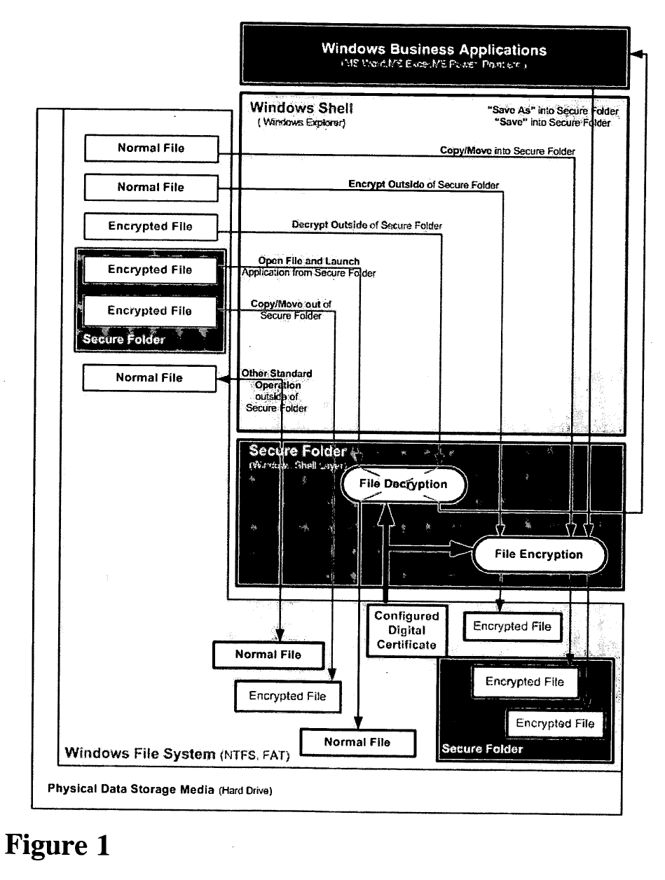

FIG. 1 shows an overview of the secure file utility system including two file storage areas used for secure file utility operations. The contents of My Vault may be stored in (for example) in “\Documents and Settings\<user name>\Application Data\Identities\<hash of thumbprint>\.”

What is presented to the user in Windows Explorer is a view of the folders and files stored in this location. This location was chosen to ensure that each user has his/her own private My Vault. The <hash of thumbprint> is an MD5 or other cryptographic hash of the thumbprint found in the user's personal digital ID used to encrypt the files and this allows files encrypted with more than one user's personal digital ID to coexist in this storage location.

The second location is used as temporary storage. Files must be decrypted and stored in this location so that applications may operate on them. The location of this temporary storage location may be “\Documents and Settings\<user name>\Local Settings\_{—}0071010.”

A temporary filename may have the form: ˜˜{<GUID>}_<path within My Vault><filename>, where the following are defined as:

<GUID>_The Microsoft Global Unique Identifier issued by the secure digital ID management utility corn object (CommV3R);

<path within My Vault>_This is the path within My Vault with backslashes(\) replaced with underscores (_); and

<filename>_The filename of the file as seen in My Vault.

The temporary files are deleted for the configured user's personal digital ID when the user logs out of windows. This ensures that these unencrypted files cannot be viewed after the windows session is completed.

When a file is encrypted, its filename is modified to indicate that it is an encrypted file. The indicator “.cmr” may be added before the file extension. For example a file called “contract.doc” may be modified to “contract.cmr.doc.” Preserving the filename extension in this fashion allows Windows Explorer to display an appropriate icon with the file, even though the file is encrypted.

Not all icons are necessarily preserved. Those icons contained within a file, such as is the case in a “.exe” file, may not be displayed as the icon part of the file is encrypted and Windows cannot interpret the icon. The same may be true for thumbnail display of images.

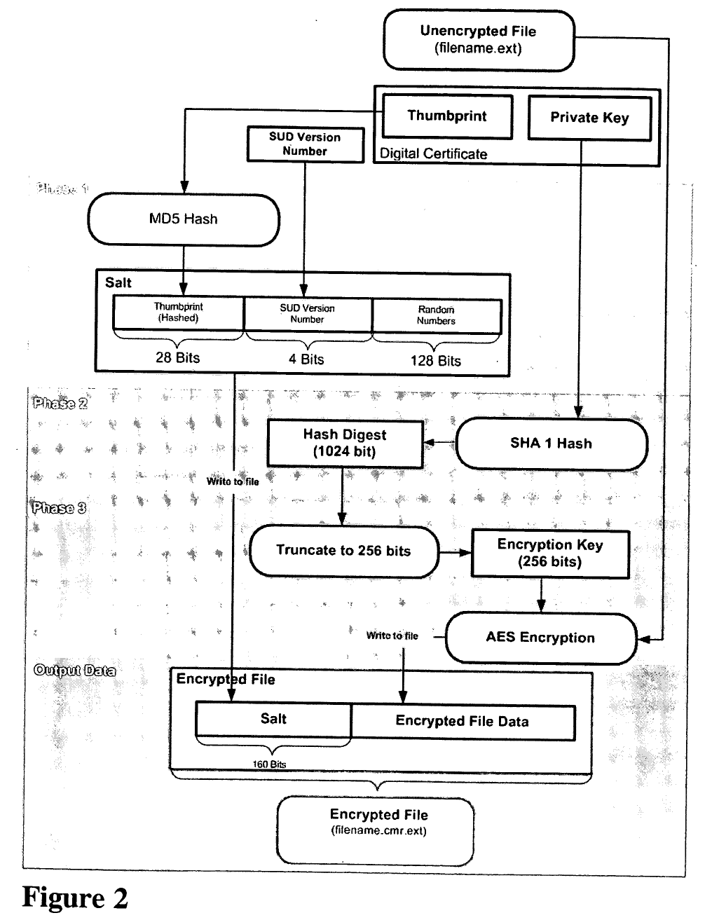

A graphical depiction of the how a file is encrypted is shown in FIG. 2. When a file is encrypted, the thumbprint from the user's personal digital ID is hashed using MD5, the version number associated with the SUD and some random data are combined to form what is termed “Salt” (Phase 1). The SUD version number allows the format of the files to be changed in a subsequent version of the secure file utility. The secure file utility can identify files of old versions and upgrade them to the current version.

In Phase 2, the private key from the user's personal digital ID is hashed using SHA1 to create the HashDigest. The HashDigest is used as a key to encrypt the file data. In Phase 3, the Salt is first written to the output file. Then the file data is encrypted using AES and the HashDigest as the encryption key. The encrypted data is appended to the output file.

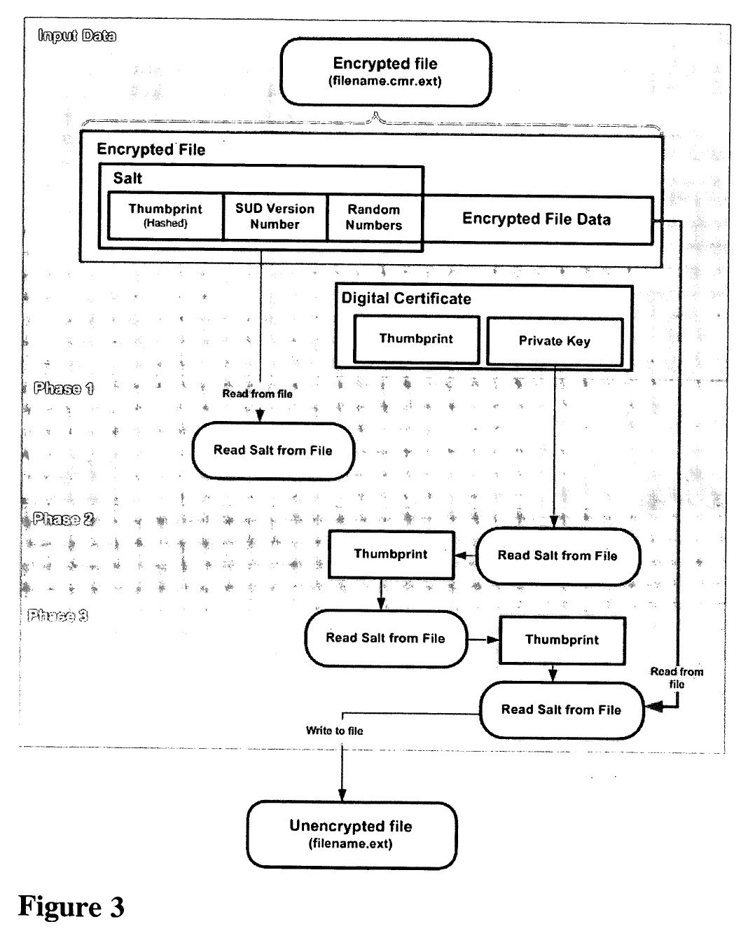

FIG. 3 shows the data flow of the decryption process. When a file is decrypted the “.cmr” is removed and the original filename is restored.

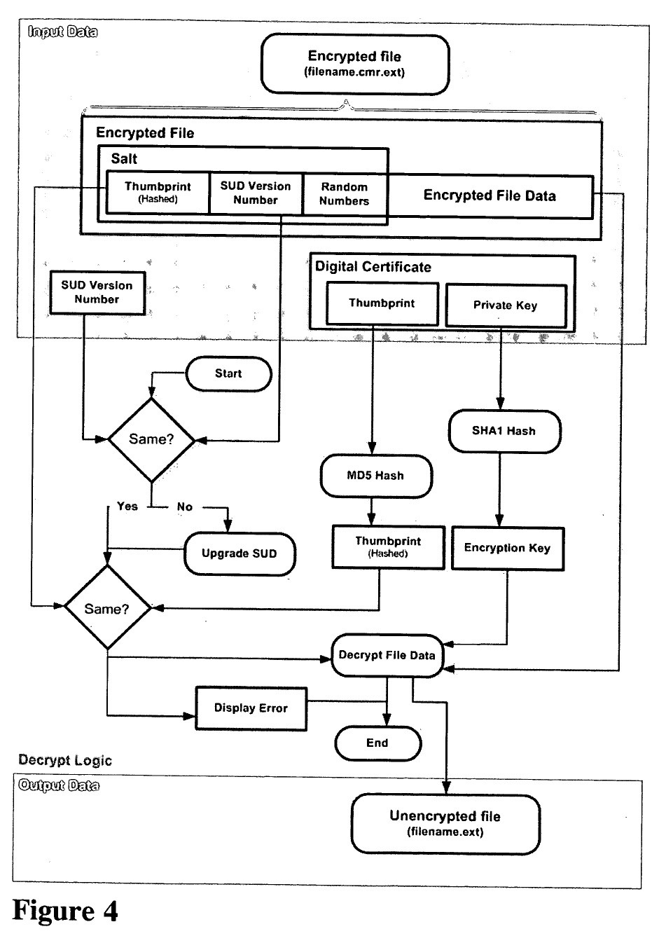

In Phase 1, the Salt is read from the file that is to be decrypted. The Salt is used to verify the SUD version number and that the currently configured user's personal digital ID was used to encrypt the file. This logic is shown in FIG. 4. Some of this logic may not be required until the SUD structure and version is changed in a subsequent release.

In Phase 2 the HashDigest is created by hashing the Private Key, taken from the current user's personal digital ID, using SHA1.

In Phase 3 the HashDigest is truncated to 256 bits and used as a key to decrypt the file data. This decrypted data is written to the appropriate file.

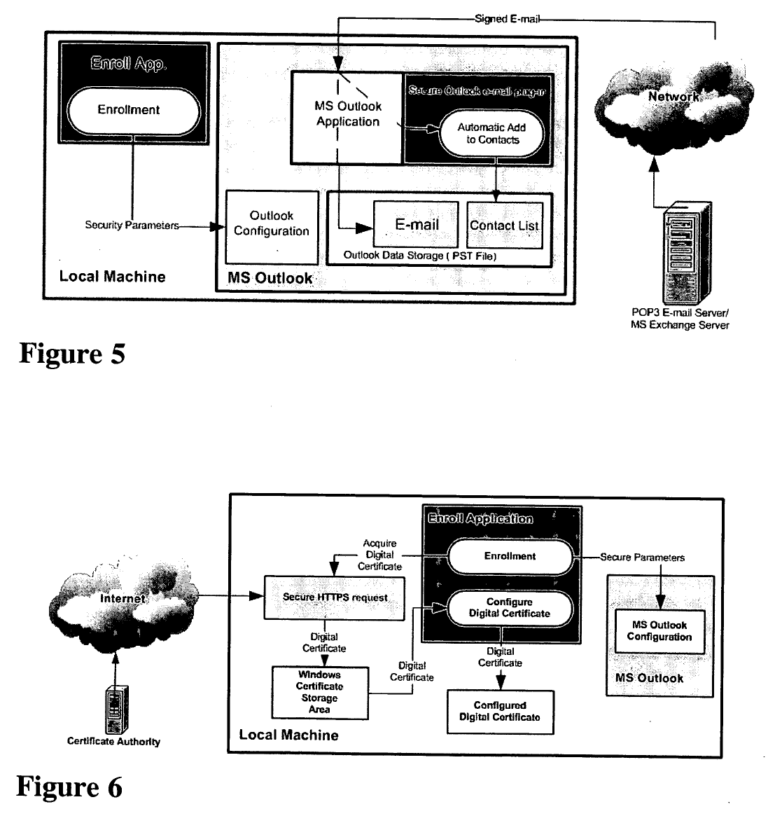

As a component of the toolkit, the secure email utility is an extension to MS Outlook and provides a very simple interface for users to secure their e-mail. FIG. 5 shows an overview of the secure email utility. The main functions of the secure email utility are:

Automatic Add to Contacts—When a signed message is received by Outlook and the sender of the e-mail is not within the Outlook's contact list; the secure email utility automatically creates a contact and saves the sender's certificate. As the recipient's certificate is required to encrypt a message, the “Automatic Add to Contacts” feature greatly simplifies the sending of encrypted e-mail. There is no longer a need to locate a signed message and manually add it to the contact list before sending an e-mail.

As a component of the toolkit, the secure digital ID management utility provides services that allow the user to acquire a personal digital ID (digital certificate) and choose which personal digital ID is used (configured) for operations in the other components. The secure digital ID management utility is a Windows Application. FIG. 6 shows an overview of the secure digital ID management utility configure or configuration. The main functions of the secure digital ID management utility configure includes enrollment and the process of acquiring a user's personal digital ID. The secure digital ID management utility configure uses Internet Explorer to browse to a Certificate Authority. The user then enters the appropriate information and if the information is valid, the user's personal digital ID is issued and is stored by Internet Explorer in the Windows Certificate Storage Area. The secure digital ID management utility configure also automatically configures the user's personal digital ID for use.

To configure the user's personal digital ID and in order to use the user's personal digital ID, it must be selected for use. This is called configuring the user's personal digital ID. The secure digital ID management utility configure provides a manual interface that allows the user to configure a the user's personal digital ID. It also configures the user's personal digital ID automatically during enrollment.

If MS Outlook is installed, the secure digital ID management utility configure configures Outlook to send secure e-mail. This is done automatically during enrollment.

The toolkit has been optimized to work with third-party credentialing systems, such as GeoTrust's True Credentials, to create the industry's first strategic managed security solution leveraging existing corporate applications.

The toolkit is a jointly developed solution that is not a point solution but works as a strategic solution dealing with strong authentication from a trusted source, secure communication, secure storage, digital document integrity and much more. The toolkit is also a managed service that has dealt with the traditional complexity of digital ID deployment so that users are up and running in approximately 90 seconds. A simple user interface is provided that is based on and strengthens the corporate applications users are already working with. The toolkit set forth herein scales across larger networks including those across different commercial or institutional entities.

Many institutions may have opted to use multiple, single-factor or limited technical point solutions to address multi-factor business needs. This approach increases the level of difficulty for administrators to deploy and manage as well as making it more complicated for customers to use. It is also the most costly approach.

The toolkit is a security toolkit relying upon a trustworthy credentialing system such as GeoTrust's trusted True Credentials x.509 digital ID as the authenticating mechanism for encryption and digital signature validation. The toolkit includes four primary products based on applications and user interfaces already deployed and being used by several existing entities (corporate and otherwise).

The secure digital ID management utility is the simple user interface for obtaining and managing the users' personal True Credential digital ID.

The secure email utility automatically configures and associates the True Credentials digital ID with Microsoft's Outlook/Outlook Express clients, including automatically adding users' public keys to the Contact List. Novell's Groupwise, IBM's Lotus Notes and Eudora email clients are also supported. As mentioned above, the secure email utility enables easily sent and secured email messaging.

Organizations and users need to know, with a high level of assurance, that they are conducting business with someone who has been properly authenticated. Passwords are not very effective. However, third-party credentialing services such as GeoTrust's True Credentials may be a strong authentication source. True Credentials working with the toolkit may make the historical issues associated with deploying and managing digital IDs a thing of the past.

The resulting unique strategic solution provides an important and distinct capability of digitally signing electronic documents and emails. Documents digitally signed with True Credentials and the toolkit meets the federal and state requirements for being legally admissible in a court of law. No other solution can provide this level of electronic trust and assurance.

The toolkit is a collection of software products that provides security for common desktop operations. The toolkit provides simple enrollment for digital certificates, simplification of secure email and file and folder encryption. The toolkit's core components include:

The secure digital ID management utility is the control panel for the toolkit. The secure digital ID management utility is where a user goes to enroll for their digital certificates and to handle the management of configuration task such as passwords administration.

The secure email utility is a component that enables users to secure their email with ease. The secure email utility accomplishes this by using end user authentication and encryption standards built into MS Outlook and Outlook Express. Sensitive corporate/organization or personal emailed information, including its attachments, may be secured and protected. The secure email utility automatically updates and stores the contact information of the sender in the user's address book for all signed incoming email messages that have been read. This not only provides easy storage of contact information, but also a transparent tool for managing individual public certificates to send and receive secure email.

The secure file utility is an extension to Windows Explorer that creates a secure storage area, called or generally denominated as “My Vault,” generally integrated into the Windows Explorer interface. The secure file utility enables users to drag and drop files into My Vault with the secure file utility automatically encrypting the information using the user's personal digital ID (as configured with the secure digital ID management utility). Users can create multiple directories and folders to organize all of their secure encrypted information. The operations within My Vault may be designed to be as similar as possible to normal operations with Windows Explorer.

A user's personal digital ID is a digital ID or digital certificate. The user's personal digital IDs are a user's electronic version of an online identity. It provides strong and/or reliable authentication or verification that it is actually the user when trying to access secured information. Users can use their user's personal digital ID to prove their identity in an electronic message (via secure email utility) or the user's right to access information or services on their computer (via secure file utility) or via the Internet.

The secure digital ID management utility is analogous to the control panel for the toolkit. The secure digital ID management utility is where a user goes to enroll for their user's personal digital ID and to handle the management of configuration task such as passwords administration.

The secure digital ID management utility provides a simple and easy way to enroll and/or acquire personal digital ID (digital certificate).

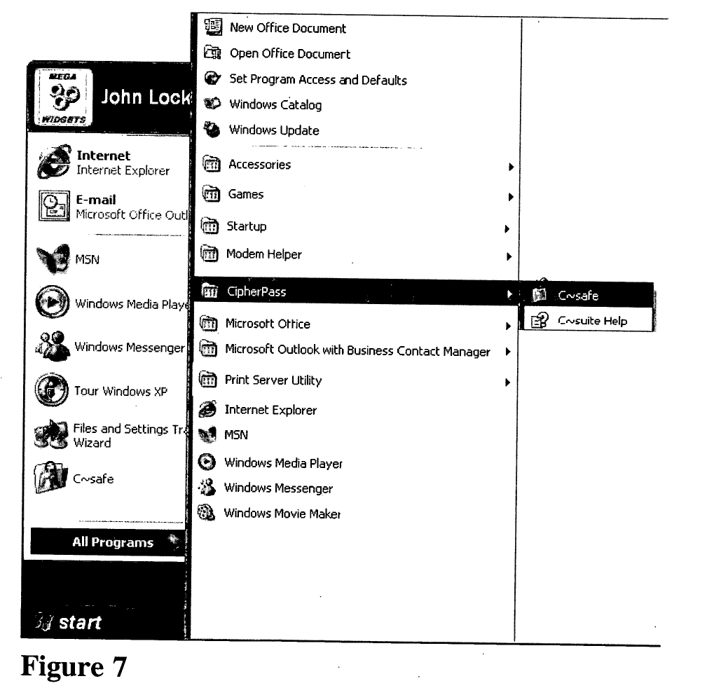

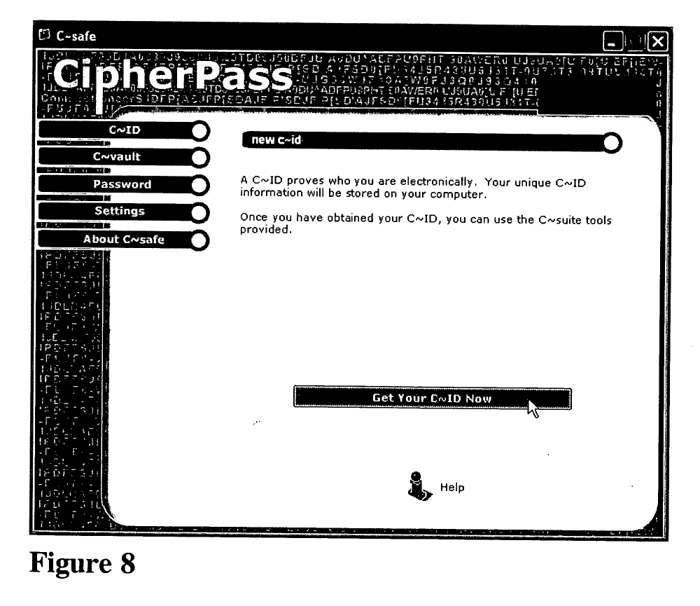

FIG. 7 shows one method of initiation of the secure digital ID management utility, in this case designed under the name of “C-safe.”

Enrolling for a personal digital ID is the process of acquiring a digital certificate by submitting enrollment data and validating it against a pre-registered database or otherwise. Once successfully authenticated, the user's personal digital ID will then be downloaded and the secure digital ID management utility may associate this personal digital ID with Outlook (via secure email utility) and the secure file utility.

A user may launch the secure digital ID management utility by double clicking on the secure digital ID management utility icon on the desktop and then click the indicated “Get your personal digital ID now” button as shown in FIG. 8.

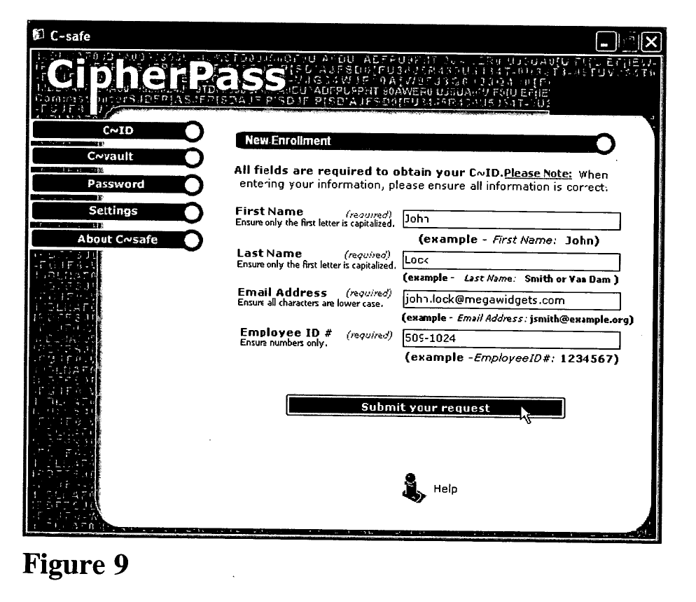

In enrolling for personal digital ID, the user completes all the fields on the New Enrollment form. It is very important to enter the correct information to successfully obtain the personal digital ID. Personal information may be required as shown in FIG. 9.

The user then may activate or click the “Submit your request” button. The user's personal digital ID request will then be processed. Once validated, the user will see a confirmed message, such as “Congratulations! You have successfully enrolled and configured your new personal digital ID” in the secure digital ID management utility console.

If the user gets an error message, the information fields should be double checked, the information re-entered and re-submitted. If the error message persists, the user may need to contact the administrator.

For manual configuration of the user's personal digital IDs, instructions may be provided.

To configure the secure digital ID management utility settings, from the secure digital ID management utility's main menu, a user may click on SETTINGS, then the button SECURE DIGITAL ID MANAGEMENT UTILITY SETTINGS or similar.

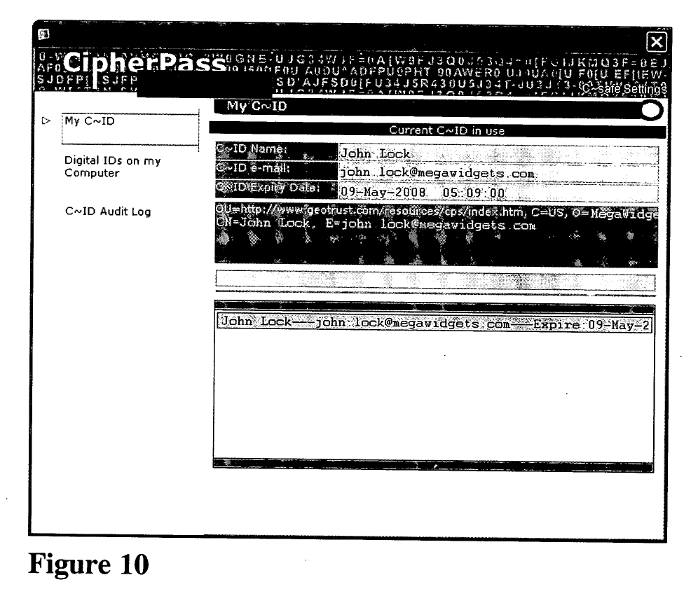

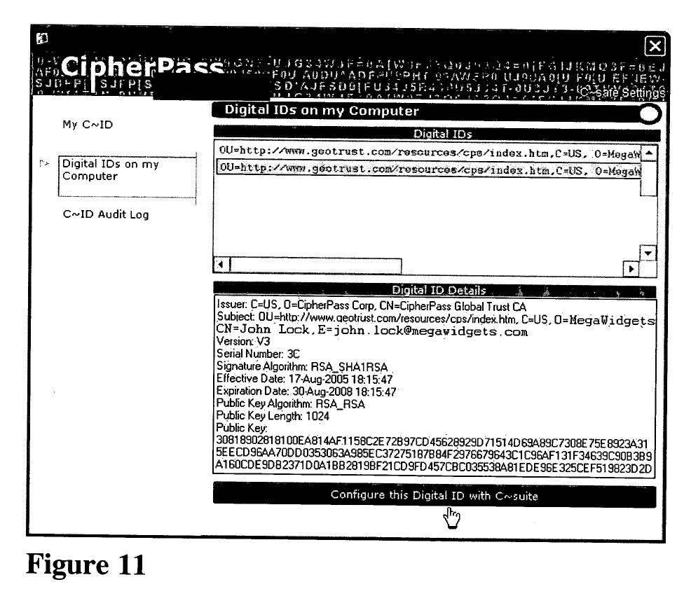

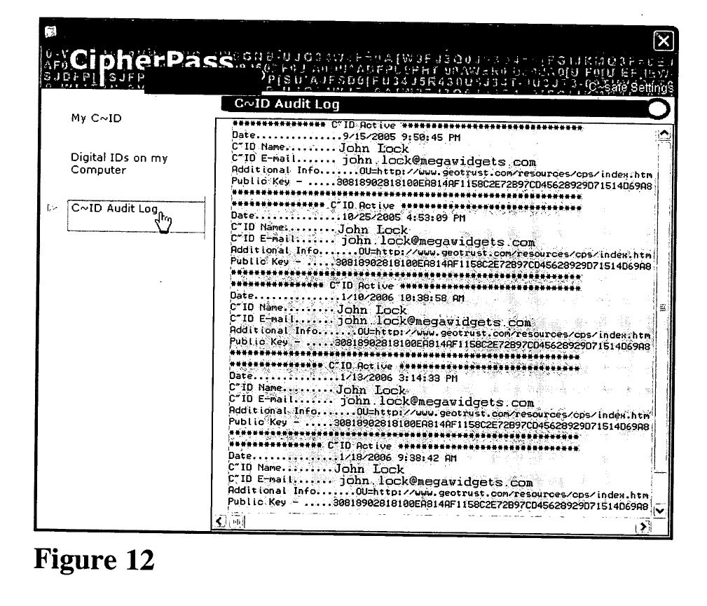

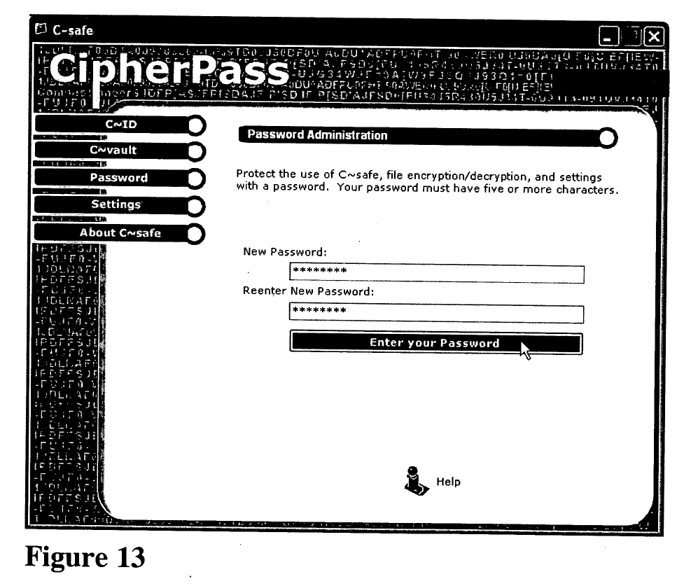

A screen as in FIG. 10 may appear. There may be 3 screens which make up the Settings section of the secure digital ID management utility: a My personal digital ID screen (FIG. 10), a Digital IDs on my Computer screen (FIG. 11); and a user's personal digital ID Audit Log (FIG. 12).

The screen shown in FIG. 10 is “My personal digital ID” screen and from here the user may view the details of his/her personal digital ID. The user may manually configure the user's personal digital ID by launching the secure digital ID management utility as by double clicking on the secure digital ID management utility icon on the desktop. By then clicking on “Settings” and then on the button for the toolkit Settings display is made of the secure digital ID management utility settings window. By clicking on Digital IDs on my Computer, the window in FIG. 11 is displayed.

The user may select the Digital ID that is to be configured by clicking on the appropriate line under the title Digital IDs.

As shown in FIG. 12, user's personal digital ID Audit Log tracks which of the user's personal digital IDs was in use during a particular time. This is useful when the user may be using multiple personal digital IDs.

To provide an additional layer of protection for accessing the “My Vault” area or changing secure digital ID management utility settings, the user has the option of implementing password protection.

To change the toolkit password, the user first launches the secure digital ID management utility by double clicking on the icon called the secure digital ID management utility or similar on the desktop or otherwise. On the main secure digital ID management utility window, the user then clicks on Password. The Password Administration screen will appear as shown in FIG. 13. The user fills in the two boxes labeled “New Password and “Reenter New Password,” then click the “Enter Your Password” button.

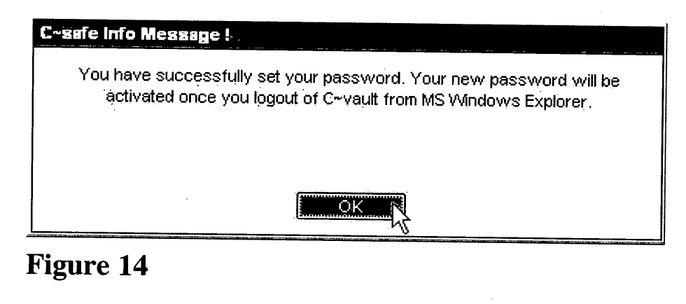

The password is then set. A confirmation message window may appear per FIG. 14. If the user forgets the password she/he can easily reset a new password.

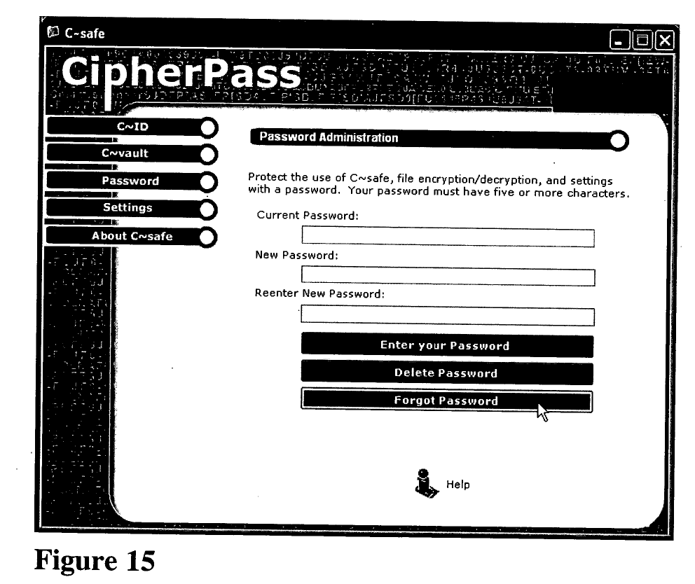

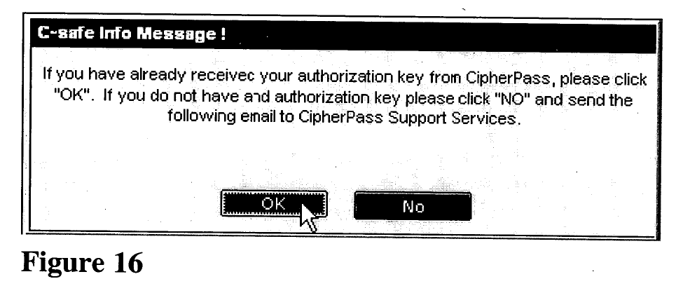

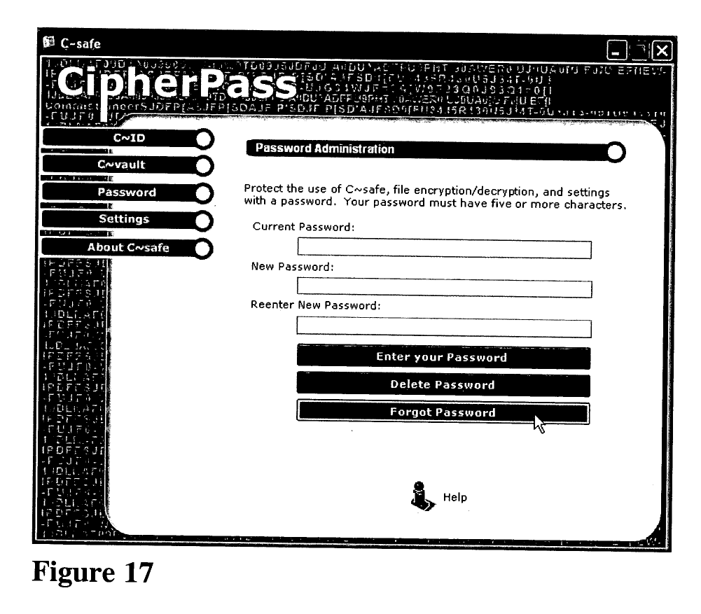

From the Password Administration screen (FIG. 15) in the secure digital ID management utility, the user clicks “Forgot Password” and then will see the message shown in FIG. 16 and click “NO” if he has not already received an authorization key.

An email message may then be automatically generated. The user should not edit this message. The user may then press “SEND” and the information may be sent to technical or other support.

Once the user and/or company are verified, the user may receive an email from the appropriate authority containing an authorization key.

The user then goes back again to “Password Administration” (FIG. 17) and again, clicks “Forgot Password.”

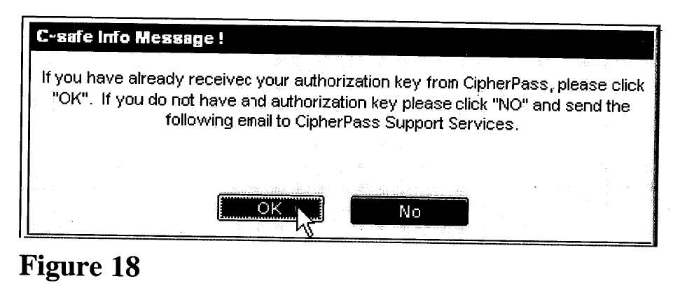

The user will see the same message again (FIG. 18). This time the user clicks OK.

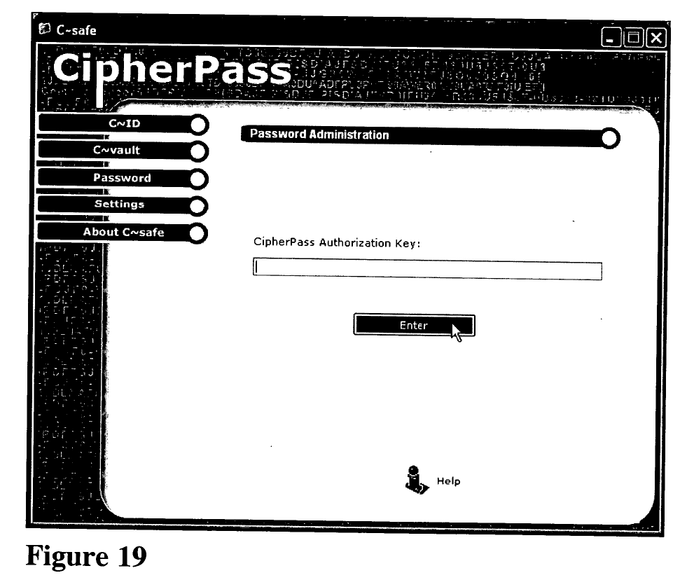

The user then cuts and pastes the authorization key into the section as shown in FIG. 19 and clicks Enter The user can then reset a new password.

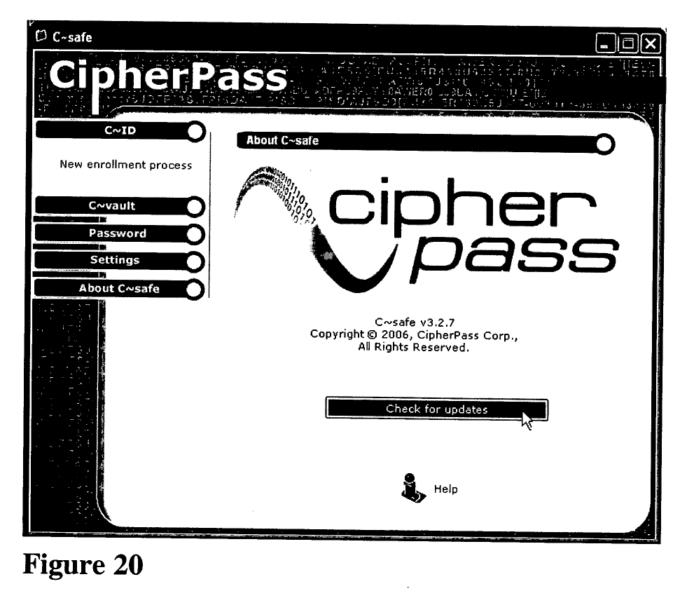

From time to time, updates may be made available to the toolkit. These updates can be accessed from within the secure digital ID management utility by clicking on “About the secure digital ID management utility” and then on “Check for Updates” (FIG. 20)

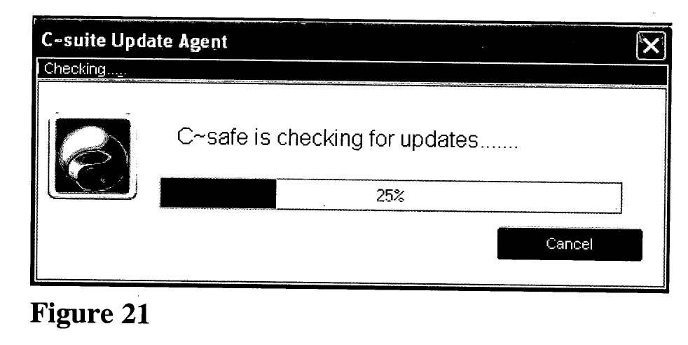

A pop-up may then appear with the message “The secure digital ID management utility is checking for updates . . .” (FIG. 21). One of two pop-ups may then appear.

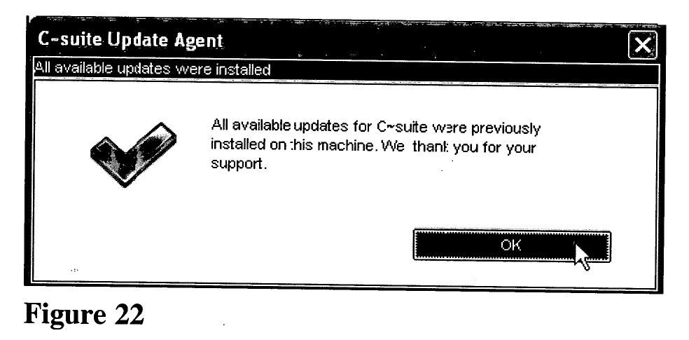

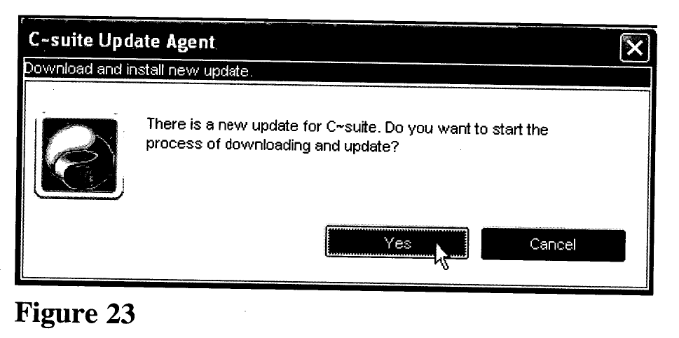

If there is no update, the user will see the window shown in FIG. 22 while if there is an update available, the user will see the pop-up of FIG. 23 and should click “Yes.”

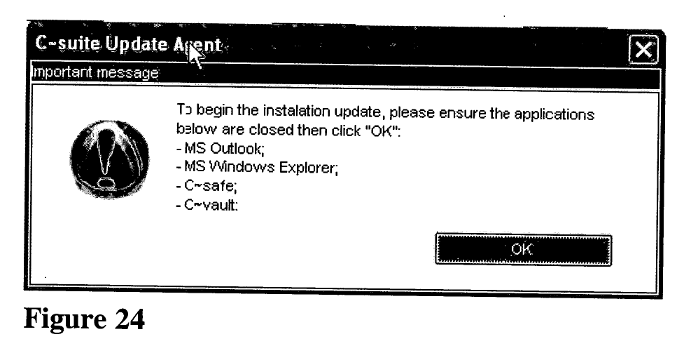

If an update is in order, a pop-up will appear telling the user that the update process is about to begin and asks the user to close all applications as shown in FIG. 24.

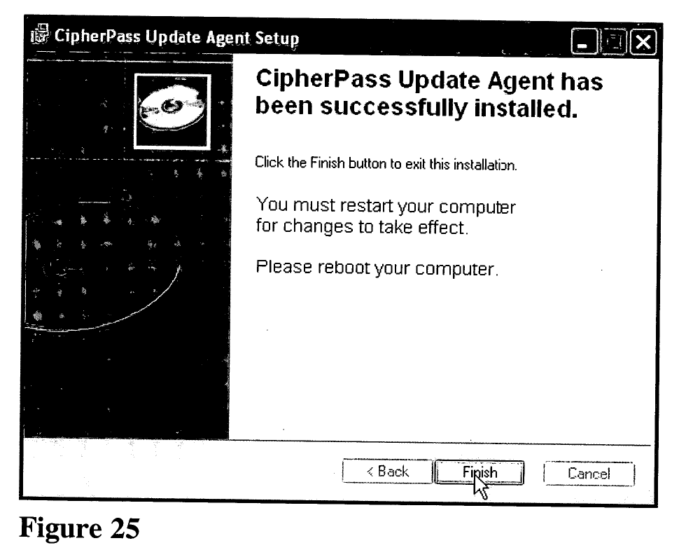

The user may then see other warning or information windows including those indicating the exiting of certain pertinent program such as MS Outlook or the like. Once the update is complete and the computer needs to re-start, a window such as that shown in FIG. 25 may be displayed.

Alternatively, the secure digital ID management utility may automatically check for updates on the 15th of the month or otherwise. When the user opens Outlook on the 15th of the month he may get a pop-up notification asking if he wants to check for an update

The secure email utility is a component of the toolkit that enables users to secure their Outlook or Outlook Express email with ease by automatically associating and configuring the user's email client with the user's personal digital ID. By using the user authentication and encryption standards built into MS Outlook and Outlook Express, The secure email utility delivers seamless integration into your everyday work procedures.

The user's personal digital ID can also be used with other programs, including Novell's GroupWise, IBM's Lotus Notes and any other S/MIME-compliant email client.

For Outlook 2000 and Outlook XP, the secure email utility automatically populates the Sign and Encrypt icons so users can easily send signed and encrypted emails.

By signing the emails, users provide assurance to the email recipient(s) that the email was really sent by the sender and that it was not tampered with. By signing emails users also send a copy of their public credentials (key) which is needed by recipients to be able to encrypt and decrypt future emails. Encrypted emails encrypt both the body of the email and all of its attachments.

To further simplify the use of email encryption for any incoming digitally signed emails, the secure email utility automatically updates and stores the public credentials (key) within the user's Contacts database. This not only provides easy storage of contact information, but also a transparent tool for managing individual public certificates to send and receive secure email.

Once the secure digital ID management utility is installed and the user has enrolled for the user's personal digital ID, the secure email utility is functional and ready to secure email for the user.

To use, the user simply composes a new message and uses the “Sign” and/or “Encrypt” buttons on his toolbar (FIGS. 29, 30, 33, and 34), and clicks “Send.”

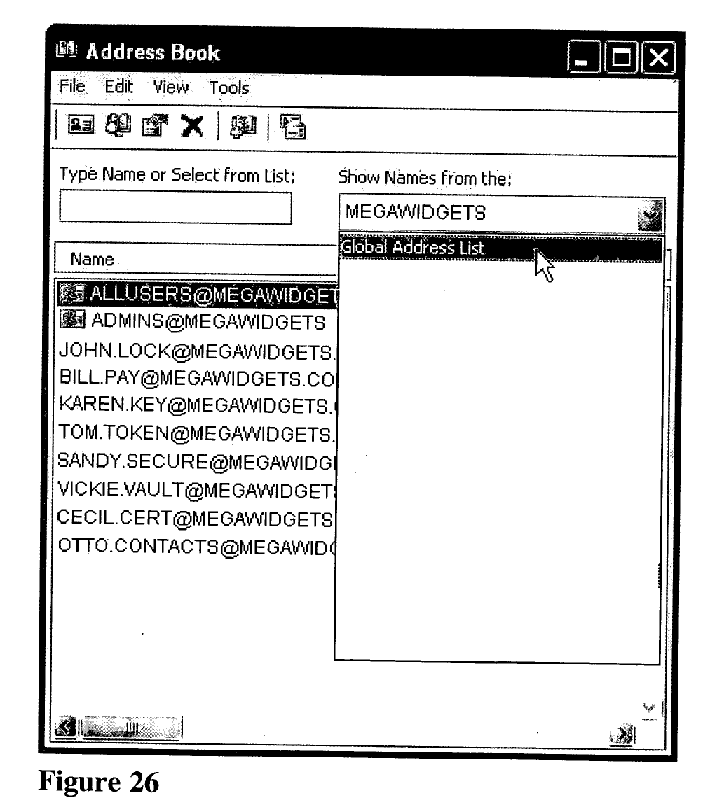

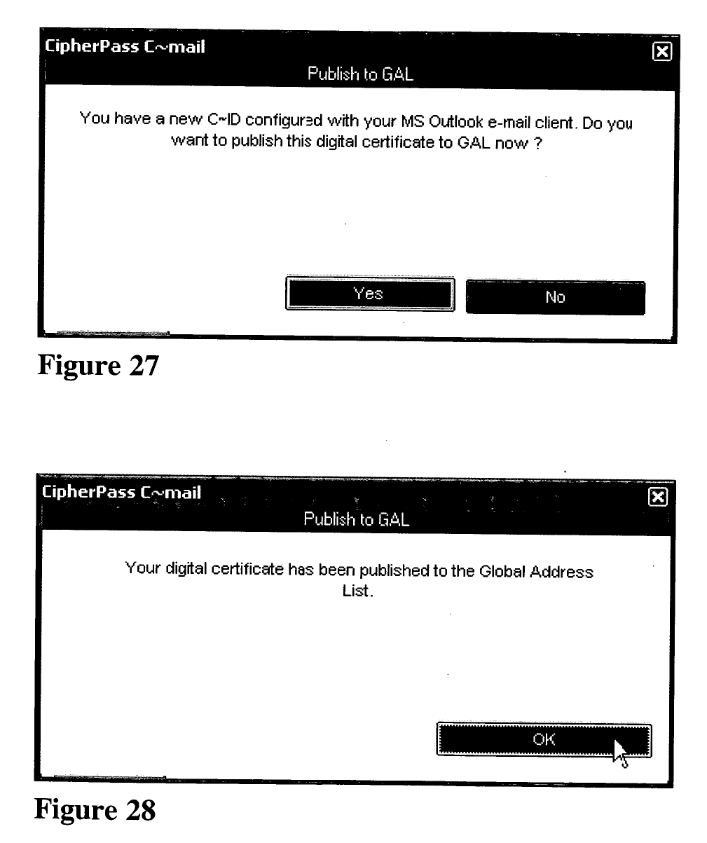

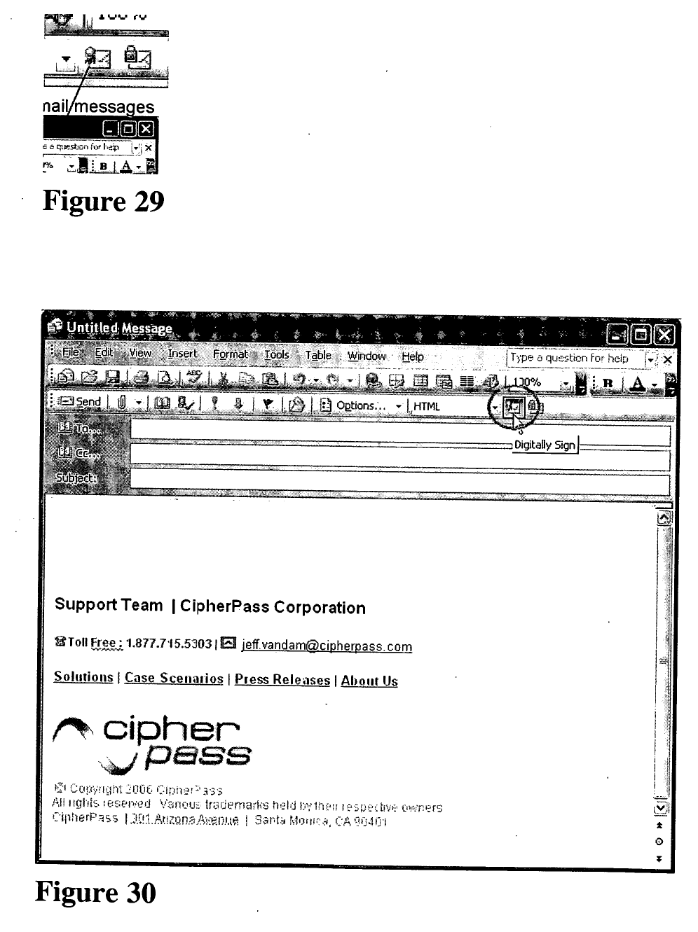

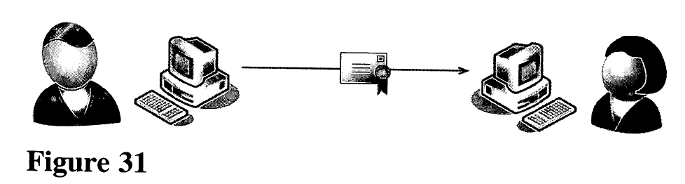

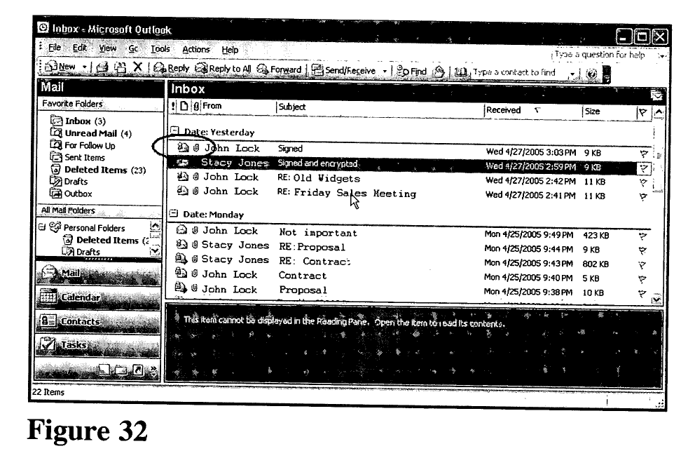

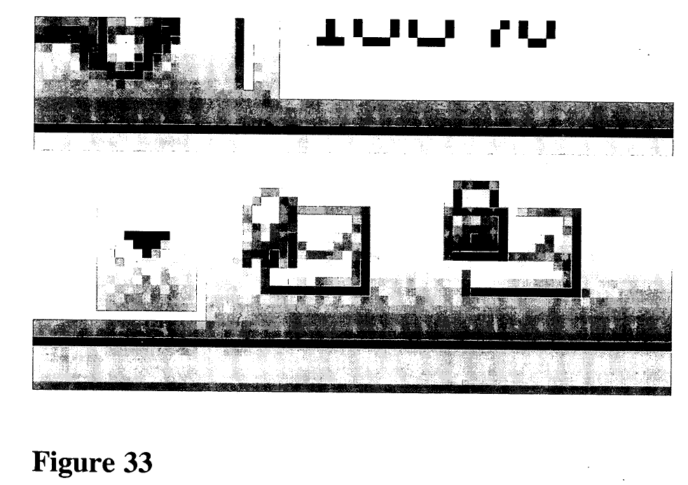

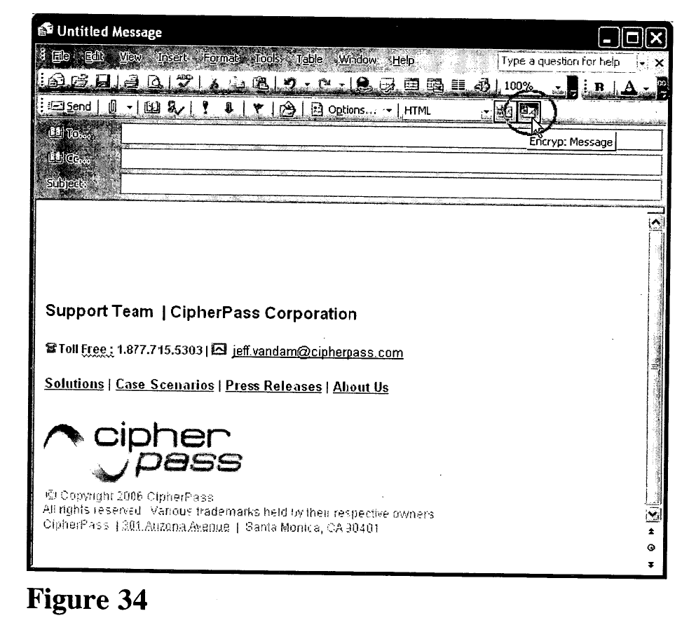

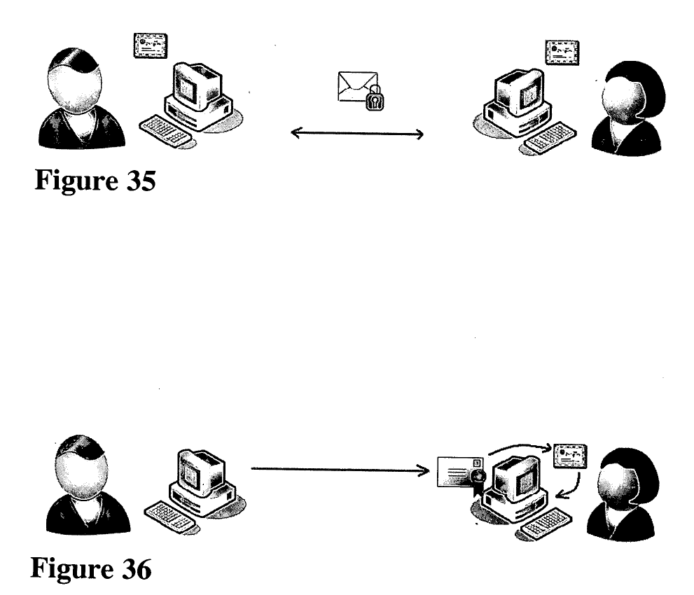

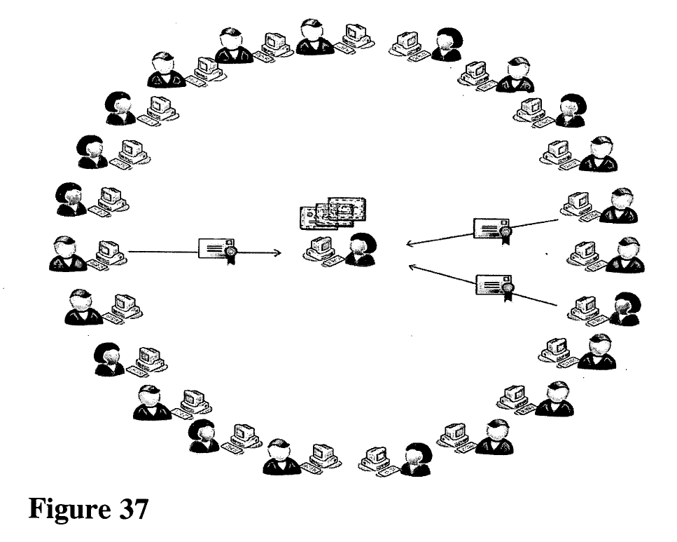

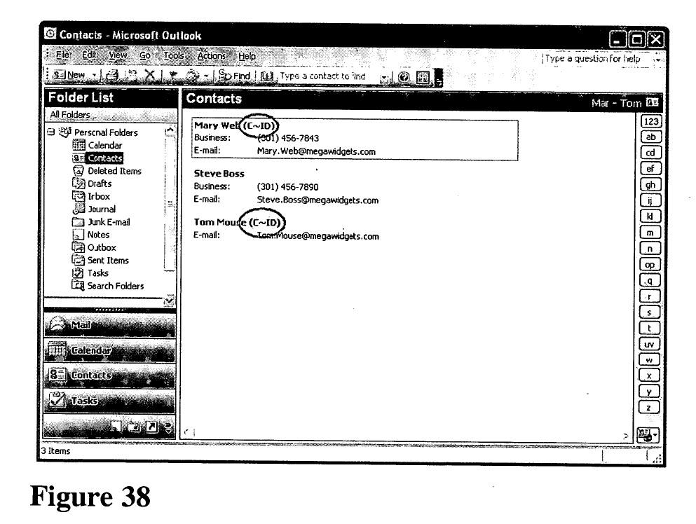

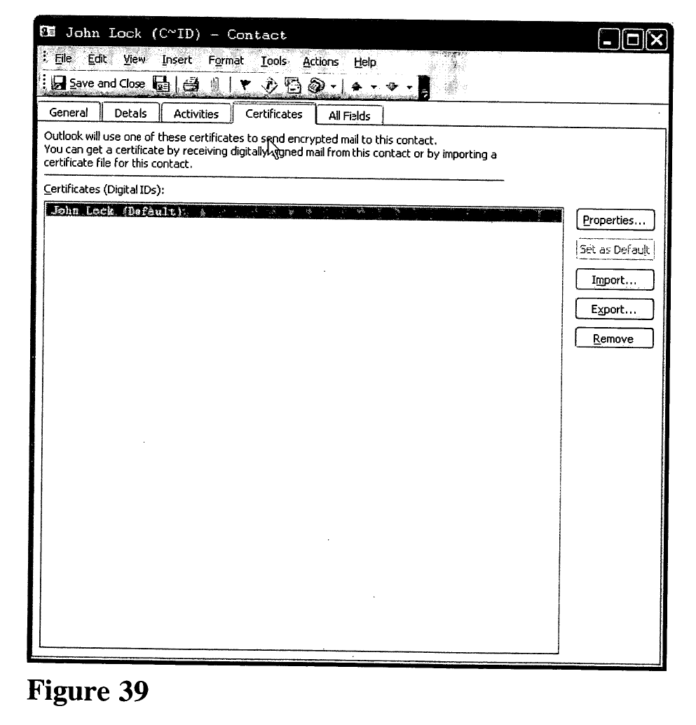

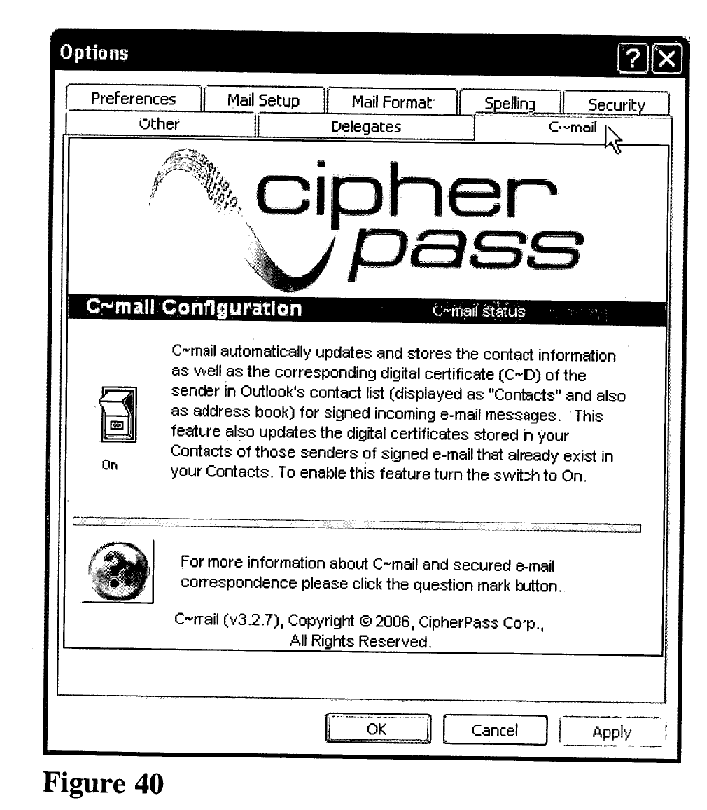

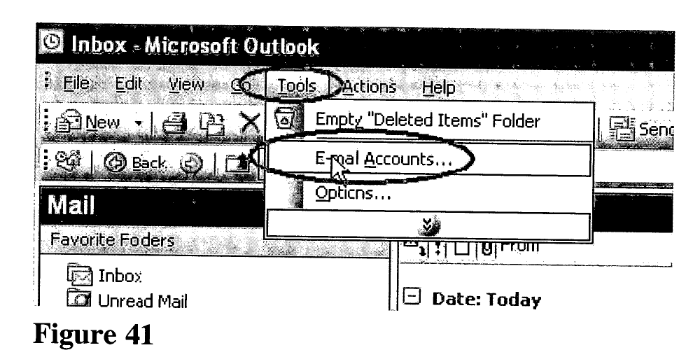

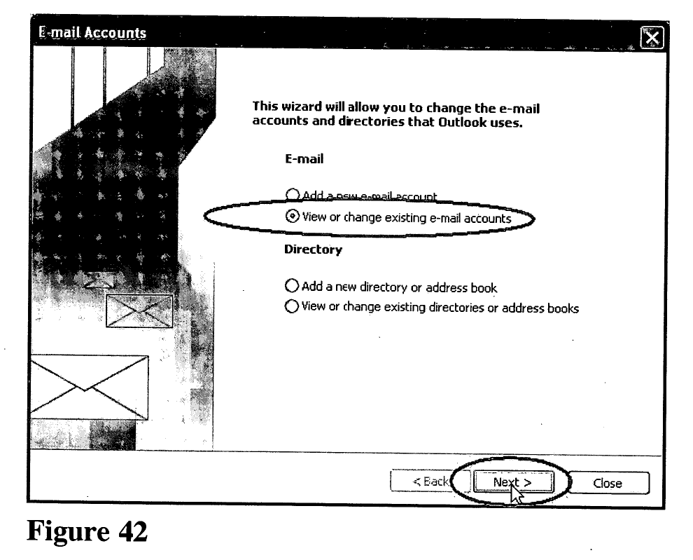

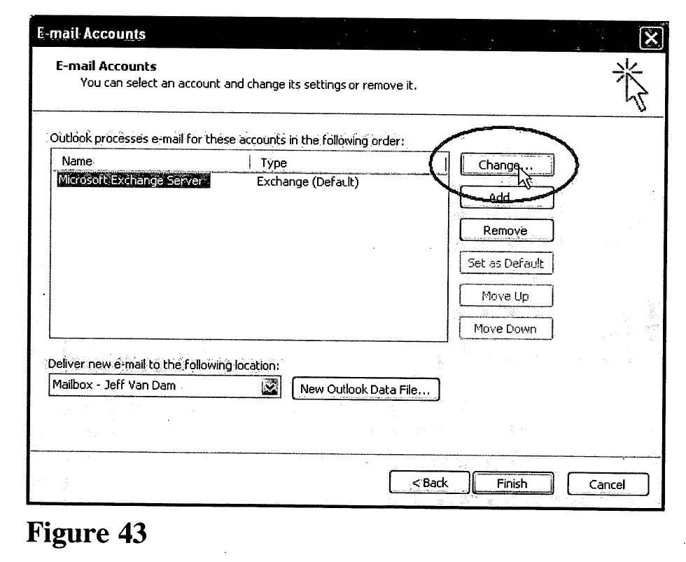

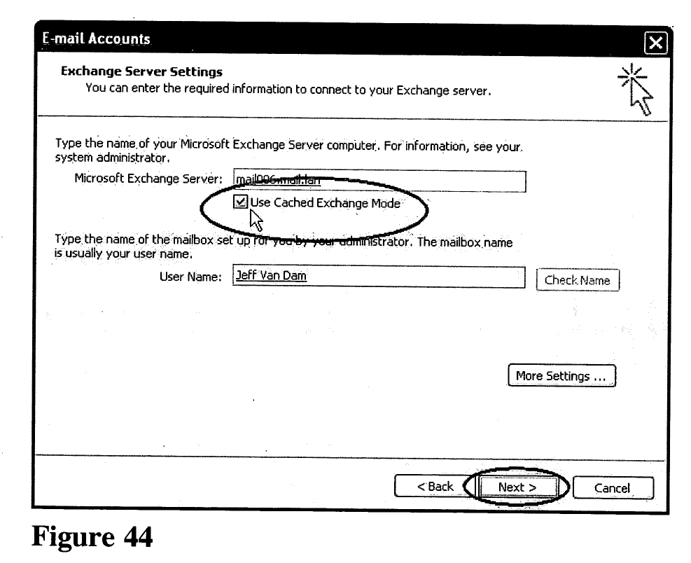

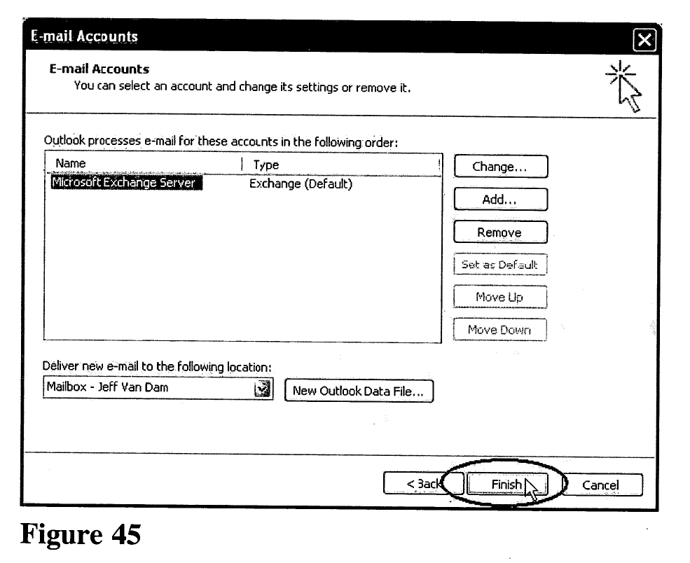

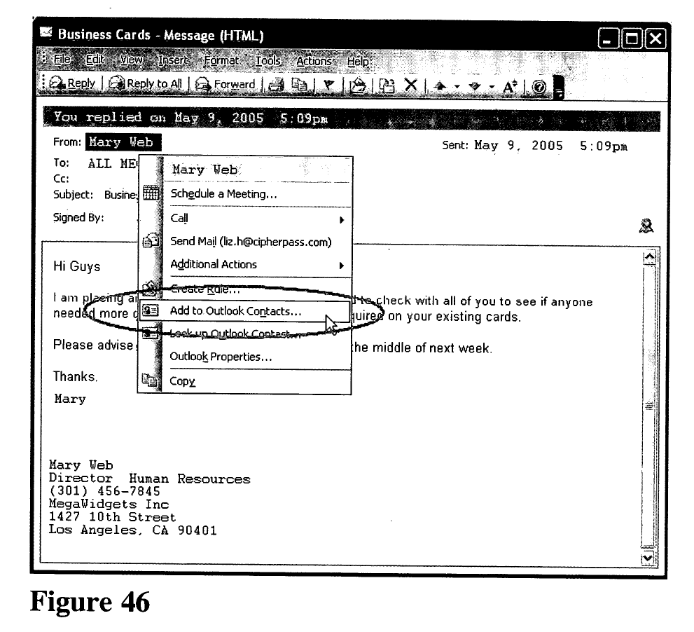

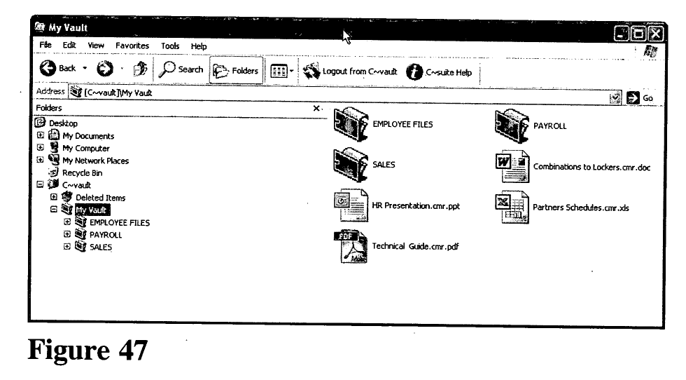

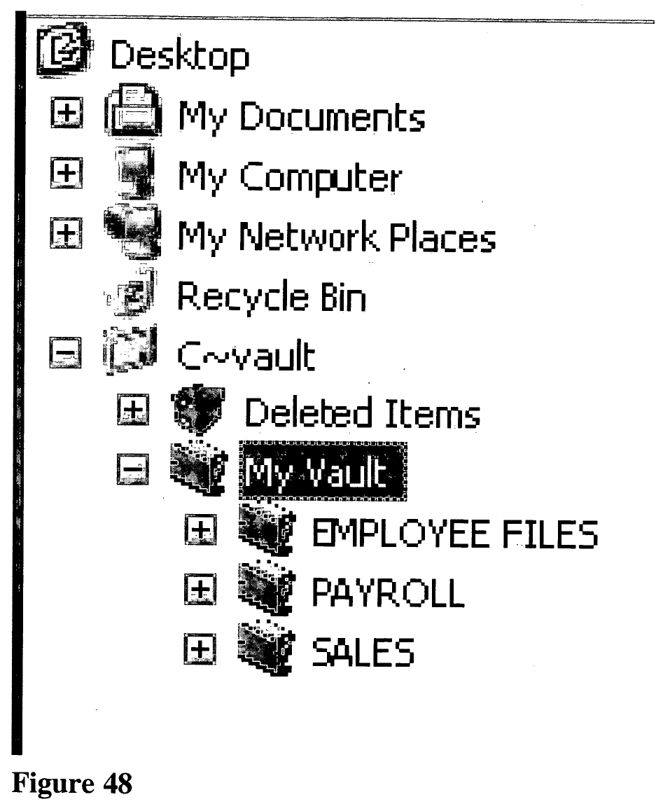

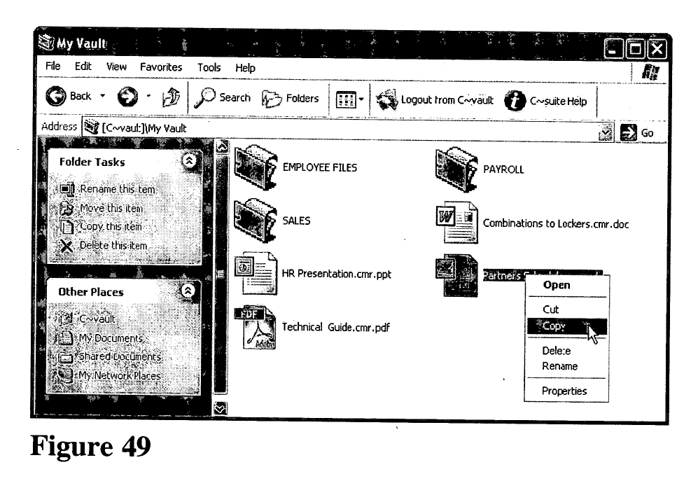

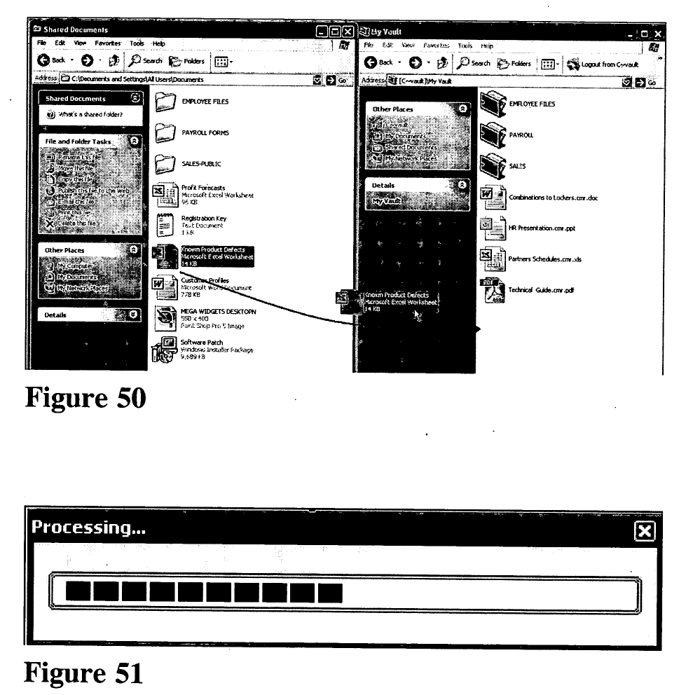

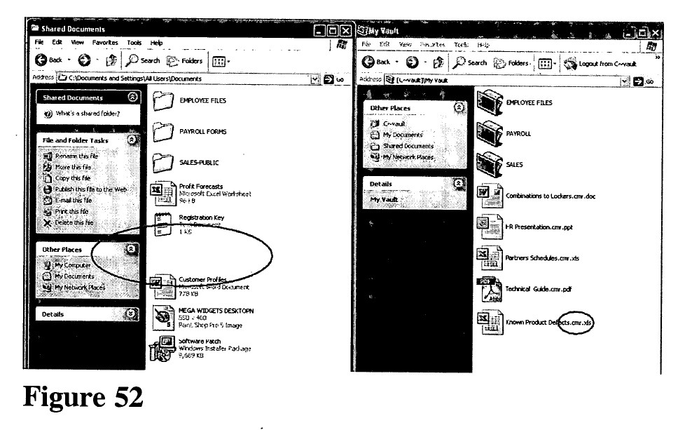

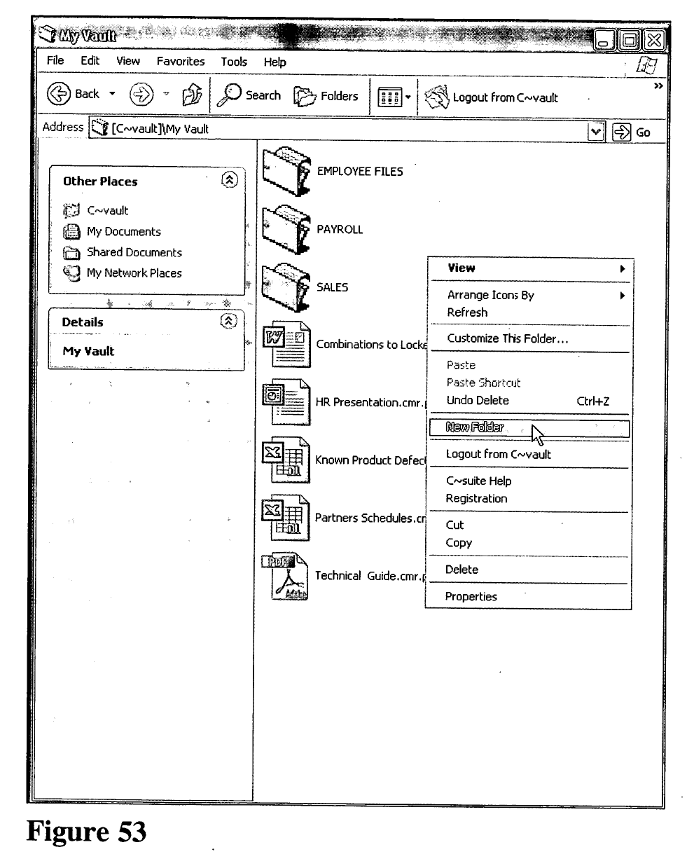

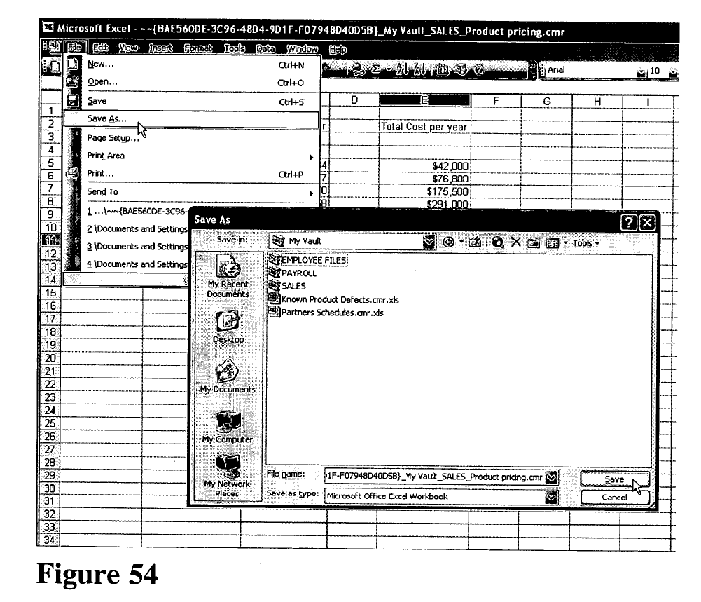

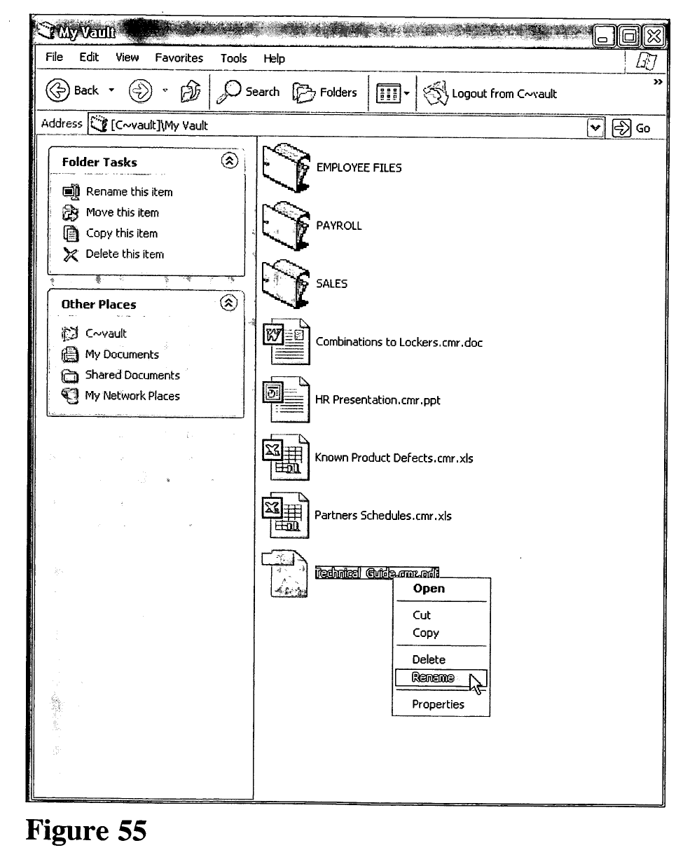

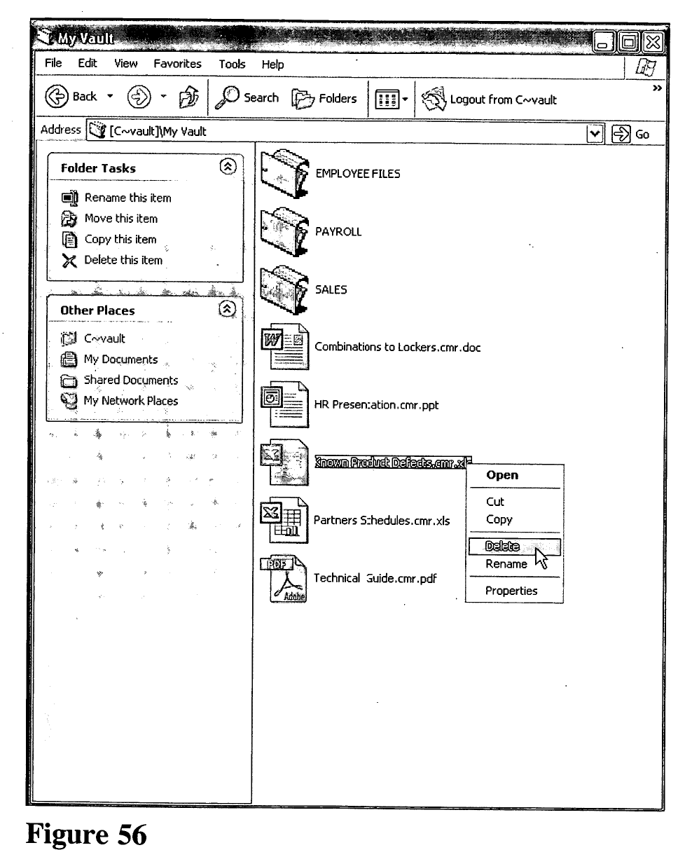

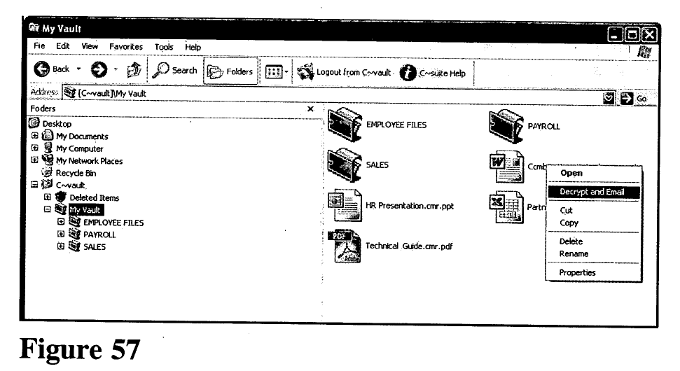

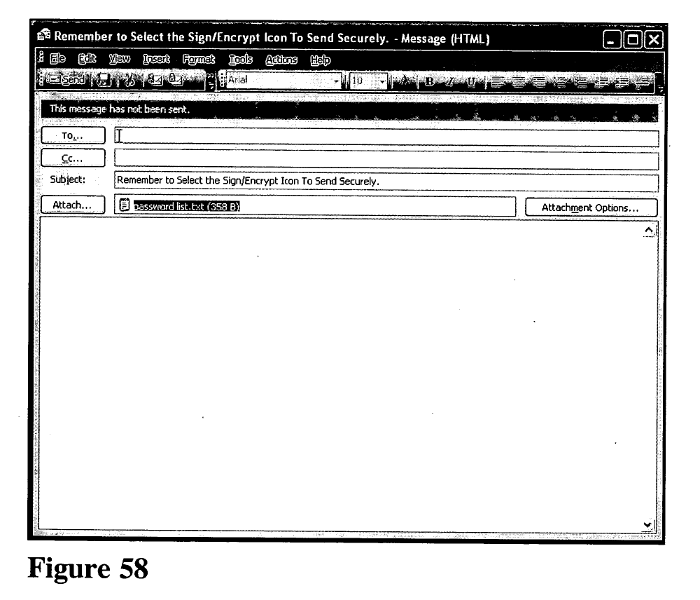

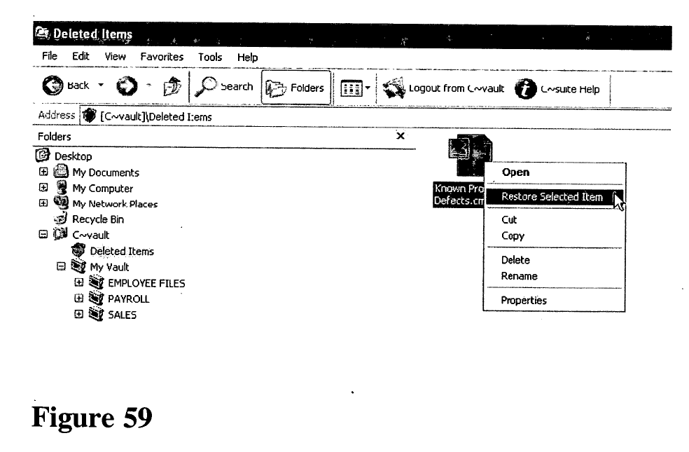

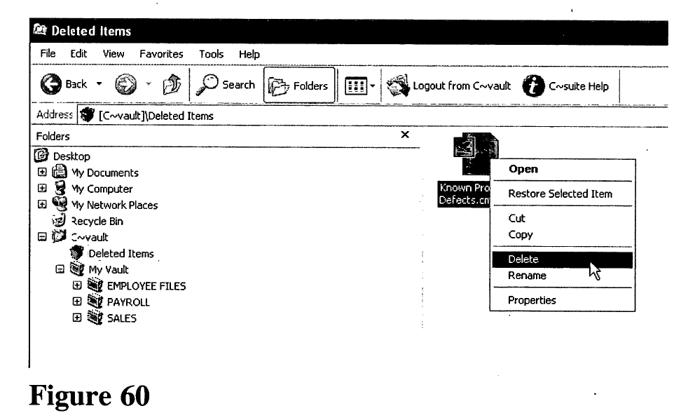

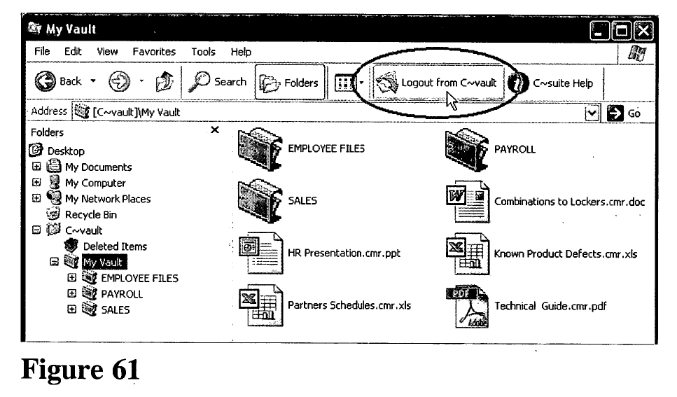

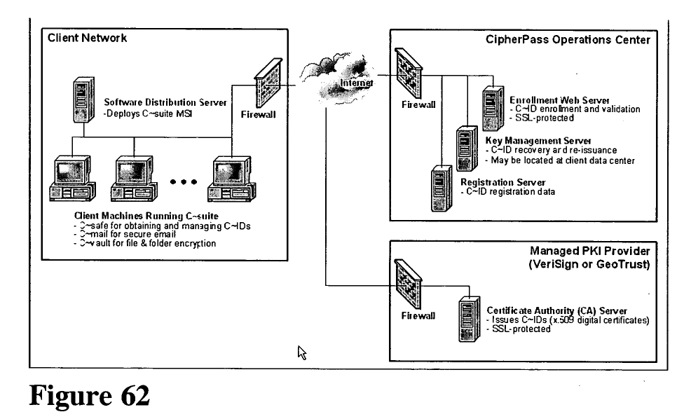

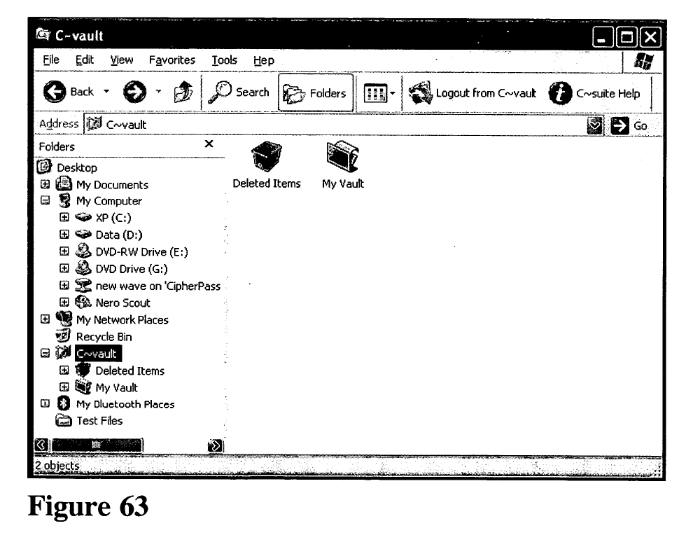

Some companies setup a “Global Address List” or GAL such as that shown in FIG. 26. The GAL is simply an address book which contains the email addresses of all employees in the company. The secure email utility offers users the option of publishing such users' personal digital ID to the GAL. The IT administrator of the organization may notify users regarding this.

Generally, such GALs are only for those on Exchange Server, a messaging program. The first time a user opens his email program, such as Outlook, after enrolling for his personal digital ID, he will see the “Publish to GAL” pop-up shown in FIG. 27. If appropriate or permitted, the user clicks “yes” and after a few seconds, another pop-up (FIG. 28) will appear telling him that the process has been completed. With the secure email utility set forth herein, digitally Signing and authenticating an email message is very easy.

After installing the secure digital ID management utility and enrolling for the user's personal digital ID, the user will notice two new buttons on his tool bar at the top of the “Compose New Mail Message window” as generally indicated in FIGS. 29 and 30. These 2 buttons appear on your outgoing email messages

To sign a message, the user clicks the Digitally Sign icon, which appears in FIG. 30 as an envelope with a little ribbon. Signing a message attaches the user's personal digital ID to the message. This proves to the recipient that the user (and only the user) sent the message.

A digital signature used in conjunction with the secure email utility should not be confused with the Signatures automatically added to every email such as the “Support Team” signature shown in FIG. 30 as part of the body of the email. Digitally signed messages generally appear different than regular unsigned email.

FIG. 32 shows how a signed message is displayed. All the emails that a user receives that are signed by the sender may have a visual identifier, such as a little red ribbon, on them.

Encrypting messages under the secure email utility is just as easy as signing them. The user clicks on the “Encrypt” button, which may be identified as an envelope with a little blue padlock or otherwise. When encrypted, a message can only be decrypted and viewed by the intended recipient. The “Encrypt” button may be located right next to the “Digital Signature” button as shown in FIG. 29, 30, and 33. Messages may also be sent signed and encrypted. The Encrypt button is shown on circled in FIG. 34.

In order to encrypt a message the user must have the intended recipients' signature (the user's personal digital ID, digital certificate) stored in his contacts database.

For example and as indicated in FIGS. 31, 35, and 36, John has his own user's personal digital ID and has Mary's public key stored on his computer. Mary has her own personal digital ID and has John's public key stored on her computer. As users like John and Mary receive and open signed incoming email messages, the secure email utility automatically updates and associates the sender's digital certificate (personal digital ID) in their address books in their profile.

For example, when Mary receives a signed email from John, John's personal digital ID (his public key) is automatically added to the “John” contact in Mary's address book. If there is not a contact named “John” in Mary's address book, the secure email utility would automatically create a “John” contact profile appropriately labeled and associated with John's public key.

Further, as indicated in FIG. 37, as Mary receives digitally signed emails from others, the Contacts in her address book are automatically associated with the senders' personal digital ID or new contacts with public keys are created, as appropriate.

In Contacts, each user is able to easily tell for whom they have such contacts' personal digital IDs. If there was no existing contact, the secure email utility automatically creates one using the sender's name and appending an appropriate indicator for the contacts' public key (FIG. 38) to the new contact name.

If the contact already existed in the user's contacts database, the secure email utility updates the “Certificates” tab (FIG. 39) by storing the new public personal digital ID of the contact. This allows users to easily identify those contacts for which they have received signatures (personal digital IDs).

Users can only encrypt messages for those contacts for which such users have public personal digital IDs stored in their Contacts.

As shown if FIG. 40, from the secure email utility tab, the Automatic Add to Contacts feature is enabled by setting the On/Off Switch to On. If for any reason users do not want to use this feature, they simply click the top of the switch to turn it OFF. If Auto Add to Contacts is not working, the user should check to see if Outlook or other email program has Cached Mode enabled. If a user receives email from a MS-Exchange server, the user must have the option “Cached Exchanged Mode” enabled. Although this setting is checked and active by default, the user should be certain this feature is turned on.

Cached Mode affects the “Auto-add to Contacts” feature of the secure email utility. Without Cached Mode enabled, incoming emails with digital signatures will not be added to the user's address book. FIGS. 41-45 visually depict the activation or confirmation of “Cached Mode.”

Generally, user must restart Outlook for the new settings to take effect.

If the user has turned off Auto-Add to Contacts, he can still manually add new contacts with their associated personal digital ID.

The user may open the message by double clicking on it. He then may right click (or metatask) on the sender's name or email address and select “Add To Outlook Contacts . . . ,” (FIG. 46) then click “Save and Close” and then “OK” on the subsequent two screens presented. This will add the contact to Contacts, including the user's personal digital ID if the message is signed. This method may or may not append a visual identifier to the contact name.

The secure file utility is an extension to Windows Explorer that creates a secure storage area, called My Vault or denominated herein as “the secure file area.” My Vault is the secure version of My Documents, a file area designation well known to users of Microsoft's Windows™ in operating system. My Vault is integrated into the Windows Explorer interface allowing a user to create multiple directories and folders so he can organize his secure, encrypted information the same way he may be already familiar with. The secure file utility enables a user to drag and drop files into My Vault and the secure file utility automatically encrypts the information using personal digital ID (configured with the secure digital ID management utility). An exemplary and generally self-explanatory screen shot is shown in FIG. 47.

To access the secure file area, the user may double click on the secure file utility on his Desktop. If he has a password configured with the secure digital ID management utility, he will be prompted to enter it. Once inside the secure file utility, the user may see two standard default icons called My Vault and Deleted Items as shown in FIG. 47 and 48. By double clicking on My Vault, the user can view encrypted files. He can manage files and folders just like he would if he were operating on files and folders outside of My Vault.

The operations accessed through cut/paste (move file or folder), copy/paste (copy file or folder), drag and drop (move file or folder), rename and delete operate as normal and they are accessible through the right click popup menu and accelerator keys.

Items may be dragged and dropped Items in to and out of the secure file area by selecting an item and simply dragging and dropping it into My Vault as indicated in FIG. 49, 50, and 52. As the item is moved it is automatically encrypted by the secure file utility. When dragging and dropping items in and out of the secure file area, for security reasons, the original items are moved, not copied, from their original location.

When files or folders are removed out of the secure file area (“SFA”), the originals stay in the secure file area while the moved copy remains encrypted and protected, even on USB hard drives and recordable CDs and DVDs.

Once a file has been placed into the SFA, it remains encrypted and can only be viewed when opened from within the SFA, or removed from the SFA and decrypted. Files stored in the SFA can be opened for viewing or editing using the same methods used for unprotected files. Double clicking on the file and the normal application will run and display the file. FIG. 51 shows graphic which can indicate that the file is either decrypting or encrypting. If it is an editable file, once the file is closed, the secure file utility will save the changes and return the file to the encrypted state.

When a file is opened from the SFA, the filename and path displayed in the application does not reflect the file name seen in the SFA. More detail regarding this is given below.

To create additional folders within the secure file area, the user simply right clicks on the SFA and selects “New Folder” from the pop-up menu as shown in FIG. 53. The New Folder name window will appear. The user fills in the new file name and clicks OK. A new protected folder then appears in the SFA.

From commonly-used applications such as MS Word, Excel, PowerPoint, Adobe PDF Reader and many others, the secure file utility allows a user to “Save as . . . ” a file directly into the SFA. FIG. 54 shows this for a Microsoft Excel file. The saved file is automatically encrypted as it is saved.

Generally, the user must “Save as . . . ” into the SFA as shown in FIG. 54 and, not into the secure file utility temporary storage location in “Local Settings.” When a file is opened from the SFA, the filename and path displayed in the application does not reflect the file name seen in the SFA. More information regarding this is given below.

The secure file utility allows users to rename items within the SFA. To rename an item the user right clicks on the item and selects “Rename.” (FIG. 55) The user may then edit the name as desired.

The secure file utility allows users to delete files from the SFA. To delete an item, the user right clicks on the item and selects “Delete” (FIG. 56). The item is then sent to the folder Deleted Items. Generally, if an item is deleted from within the SFA and a file of the same name already exists within Deleted Items, the item within Deleted Items will be overwritten. In other words, Deleted Items only stores one of each item as identified by the file or folder name.

The secure file utility allows users to send a file as an attachment to an email. Right clicking on the File and choosing “Decrypt and Email” (FIG. 57) from the pop-up menu enables such transmission. The file will be decrypted and attached to a new email message (FIG. 58). The subject line may provide the user with a reminder to sign or encrypt the message.

The secure file utility allows users to restore an item that has been deleted from the SFA. The restored item appears in the home folder of the SFA. Notice should be taken that this may not be the location from which the item was deleted.

As indicated in FIG. 59, to restore a file, the user right clicks on a file within Deleted Items, and selects Restore Selected Item. To restore a folder, the user right clicks on the folder within Deleted Items and selects Restore Folder. When a folder is restored, all the contents of that folder are restored.

The secure file utility allows the user to permanently delete files from Deleted Items as shown in FIG. 60. Right clicking on an item within Deleted Items, and selecting “Delete” performs the deletion action. The item is permanently and irrecoverably removed from the user's computer.

To logout from the secure file utility, the user clicks the button “Logout” from the secure file utility (FIG. 61). If an attempt is made to access the SFA after logging out, the user will be prompted for a password, if a password has been set.

Generally copying and moving files within the SFA operates as it does outside of the SFA. In one embodiment, if a file is copied and then pasted in the same folder, the secure file utility does not create a new file with the name “Copy of . . . ” as Windows Explorer does outside of the SFA. Windows Explorer does this expecting the user to rename the newly created file to something more meaningful. To perform this operation in the SFA, the user may copy the file to another folder (using copy and paste) within the SFA, rename it and then move it back (using cut and paste or drag and drop).

The secure file utility does not allow the user to delete the SFA or “Deleted Items” folders. These are critical folders used by the secure file utility for its operations. If a file folder is created with one of these names within the SFA, it cannot be deleted.

The toolkit set forth herein has been designed to be scalable for enterprise wide deployment. Thousands of trusted Digital IDs may be deployed to the enterprise and to the enterprise business relationship stakeholders in minutes.

FIG. 62 shows a simplified depiction, logical and physical, of a typical deployment architecture. The toolkit is installed on Windows client machines and may be deployed via an automated software distribution tool, such as Microsoft's Active Directory or SMS.

Depending on the managed-PKI vendor and the corporate requirements, the Key Management Server (necessary for key recovery, re-issuance and revocation) would reside in a central secure data center, the client's corporate data center, or the managed-PKI vendor's secure data center.

After the toolkit is installed, users may simply open the secure digital ID management utility desktop icon to enroll and download their digital ID from the designated trusted Certificate Authority (CA). As shown in FIG. 6, the enrollment process may first launch a web browser session (SSL-enabled) on the user's computer in which the user would provide the necessary pre-determined authenticating data (i.e., First Name, Last Name, Email Address, Employee Number, . . . ) to download their digital ID. Once downloaded, it may be stored in Microsoft's default certificate store within Internet Explorer or alternatively to the Digital ID hardware token thus providing strong two factor authentication. After the digital ID is stored, the secure digital ID management utility associates the digital ID to the secure email utility and the secure file utility application modules and those systems would generally be available for immediate use.

Additionally, The secure digital ID management utility provides the ability to: select which digital ID to use with applications; choose optional Password Protection associated to the use of the digital ID; and audit the historical use of the digital ID with complete accuracy.

The secure digital ID management utility provides a very simple interface to allow a user to enroll for a digital ID. The secure digital ID management utility further simplifies the enrollment interface to a trusted authority, such as VeriSign or GeoTrust, by automating required actions. Streamlining the users' process for obtaining digital IDs significantly reduces the number of help desk support calls. This approach enables a corporation or other organization to simultaneously deploy thousands of digital IDs in a matter of minutes and at the users' convenience.

The task of associating digital IDs with applications has historically been a significant challenge. Although many organizations, such as Microsoft, IBM, Adobe, Cisco, Oracle and others have made many of their products interoperable with x.509 digital IDs, the management of the digital IDs has been complex and typically required considerable sophistication on the part of the user and the administrators. This sophistication is beyond the average Windows user. The secure digital ID management utility is a simple tool to manage digital IDs. The secure digital ID management utility largely remains dormant from the users' perspective.

As an additional security measure, the secure digital ID management utility provides an optional password protection feature to further protect access to the secure digital ID management utility and files encrypted by the secure file utility. Once enabled, the user must provide the proper password to view or modify the secure digital ID management utility's configuration settings. In regards to the secure file utility, files and folder cannot be accessed until the proper password is provided.

The secure digital ID management utility provides an audit log to track the periods in which different digital IDs were utilized. This is especially helpful for users who have multiple active personal digital IDs or also manage expired personal digital IDs over time so that they know which personal digital ID was used for specific timeframes.

The secure email utility provides automatic configuration and association of the digital ID with Microsoft's Outlook/Outlook Express clients. Novell's GroupWise, IBM's Lotus Notes, Eudora and Gmail clients may also be supported. The secure email utility enables users to easily send and receive third party authenticated and secure email messages.

The addition of the “Sign” and “Encrypt” icons in the Outlook tool bar if and when they are not present: provides significant convenience for novice users and those unfamiliar with secure data transactions.

The secure email utility automates the administrative tasks of associating a digital ID to an Outlook client. Once users have obtained their digital ID via the secure digital ID management utility, the secure email utility eliminates the administrative burden of manually re-configuring every required email client for secure email. This task alone has caused major enterprise digital certificate deployments to fail. The optional settings automatically configured within Outlook's Security Tab may include: labeling the security profile; enabling the “Send clear text signed messages when sending signed messages” checkbox; selecting “SHA-1” as the hash algorithm; selecting “3DES” as the encryption algorithm; and enabling the “Send these certificates with signed messages” checkbox.

As indicated in FIG. 5, the secure email utility automatically updates and stores the senders' public key from incoming email in Outlook clients Contacts Address Book. The secure email utility automatically updates and stores the contact information (Name and Email Address) as well as the corresponding certificate of the sender in Outlook's Contacts address book. This feature also updates the digital certificates of signed e-mail senders who already exist in the Contacts address book. The Auto-Add to Contacts function is transparent to the end user, with the exception of the personal digital ID or other indicating text being appended to the end of each new auto Contact entry. This is to allow the users to identify and manage Contacts entries that were automatically added.

The secure email utility automatically populates and/or installs the “Sign” and “Encrypt” icons within the main email toolbar. In its native state and depending on the version of Outlook or other email program, these icons are not readily available and would typically require an experienced user to enable these icons.

The secure file utility provides secure file and folder capabilities, based on AES encryption that may closely resemble Microsoft Windows Explorer which makes it easy to use and strongly encrypted. The secure file utility may be considered as a secure version of Windows' My Documents. The secure file utility may be a Windows Shell Layer that hierarchically exists between the Windows Shell, seen by the user as Windows Explorer, and the Windows File System (NTFS and FAT). As files are manipulated in Windows Explorer, The secure file utility intercepts certain operations and modifies them to allow the user to encrypt their files. As with all the toolkit modules, the secure file utility also relies upon the user's appropriate digital ID for strong authentication before providing access to either encrypt or decrypt files.

The secure file utility creates an area on the users' hard drive called the Secured User Data (or SUD) or the secure file area (“SFA”). The SUD is not a particular physical location on the hard-drive but a logical grouping of encrypted files. The user sees the SUD as the secure file area from Windows Explorer and this secure file area may be denominated as “My Vault.” The secure file utility also allows the user to encrypt and decrypt files outside of the secure file area.

The user of the secure file utility sees the file and folder encryption product as part of Windows Explorer. Knowledge of the operation of Windows Explorer is sufficient to effectively use the secure file utility so little or no training is required. The secure file utility can encrypt all types of digital files while maintaining their logical user interface.

Users typically transfer existing files and folders into the SFA to be encrypted by simply using Window's Drag-and-Drop capabilities. During the transfer process, the existing files and folders undergo a Move rather than just a Copy function. This is to ensure that there are no remaining unprotected copies of the data for security purposes.

All of the transferred files and folders maintain their original directory structure, including the associated “Last Modified Date.” This is crucial for file management purposes since users often rely upon the time when the file was last modified as a means of file management. Other file encryption systems typically over-write that metadata with the date and time information of when the file was encrypted.

Users can Delete, Rename, Copy or Move files within My Vault through the normal methods available in Windows Explorer. The user can Open a file from within The secure file utility and the file is automatically decrypted and loaded into its associated application. The file can then be edited and saved and returns back to the encrypted state upon closing the file.

FIG. 63 depicts the seamless integration of the secure file utility into Windows Explorer. The secure file utility encrypts individual files and entire folders on the fly while maintaining the folder structure of the associated files within the folder. An encrypted file and/or folder may be encrypted or decrypted at the same time and the file and/or folders identity and structure remains the same.

The file name of an encrypted file is tagged with a .cmr to ensure that the user can identify encrypted files. The file name remains the same, preserving the file's identity, and the file extension is preserved ensuring that the icon associated with the file can still be displayed as normal.

The secure file utility provides a mechanism to store file and/or folder contents in a secure location, accessible only by the user that stored the file and/or folder contents. All data stored in this location is encrypted using a digital ID. Files can also be encrypted outside of the SFA through a simple popup menu, invoked with a right click (or invoking a metatask) on the file.

The secure file utility provides optional password protection as an additional security option. Access to the SFA, or to the encryption and decryption functions outside of the SFA, optionally requires the user providing their password when prompted

An encrypted file can be transported or copied onto any electronic storage medium and it remains secured, including CDs, DVDs, and USB flash drives, among others.

The secure hardware token system provides stronger 2-factor authentication by securely storing digital IDs onto USB tokens, smart cards, or other hardware devices. The secure hardware token system may be portable and easy to use. The design works similar to that of an ATM bank card thus providing 2-factor authentication and access mobility. Access to a computer or an application is obtained by inserting the Digital ID hardware token and inputting the required PIN. The digital ID is read from the smart card or USB token to gain admittance to the computer or application.

The secure hardware token system may replace the Window's password logon experience with a token and a simple PIN. Conversely, the secure hardware token system can be used to logoff a Windows session, lock a Windows session, or shut down a computer altogether. By removing the Digital ID hardware token, the computer is protected from unauthorized access. In order to regain access to the account, the Digital ID hardware token is required to be inserted and the correct PIN entered.

The secure hardware token system stores one or more Digital IDs for stronger 2-factor security and user mobility.

Through the use of a simple user interface on the Digital ID management console, a user highlights their Digital ID and clicks Transfer ID to Token. The Digital ID is securely transferred from the computer to the Digital ID hardware token.

To access digital IDs, a PIN (personal identification number) may be required after inserting the Digital ID hardware token. The use of the PIN is designed to keep user involvement to a minimum. PINs using as few as four digits imitate ATM bank card use for high user acceptance purposes.

Enhanced security using digital IDs stored on the secure hardware token system to logon to a computer is a simple process requiring the insertion of the Digital ID hardware token and entering the PIN. This optional feature replaces the typical User Name and Password with secure 2-factor authentication that requires minimal user training.

With the strong 2-factor authentication associated with the secure hardware token system and the use of the simple PIN, there is no longer the need for users to change passwords every few months and/or administrators to deploy or complex user password schemes.

In the event a users PIN is compromised security has not been breached as an unauthorized user also requires the users Digital ID hardware token to gain access to the secured information or application.

Email systems including S/MIME mail as well as other PKI-enabled applications are strengthened through the combined use of digital IDs and the Digital ID hardware token. The user is able to access the digital ID stored on the Digital ID hardware token through the use of the PIN when signing or encrypting mail messages. The combined digital ID, Digital ID hardware token and PIN guarantees the authentication of the user of the system.

Use of the secure hardware token system in conjunction with the secure file utility, restricts any unauthorized access to the secure file utility and the ability to encrypt and decrypt confidential data. The secure hardware token system stores the digital ID on either a smart card or USB hard token requiring the key to be inserted and a PIN to access the confidential information on the computing device. The secure hardware token system restricts access to information protected by the secure file utility.

Use of Digital ID hardware token to gain secure, strongly authenticated access to Internet sites helps improve security. The site, through the use of a pop-up prompt, may request the user to insert the Digital ID hardware token, followed by a second prompt to enter the PIN. Upon successful completion, the user is granted access to the website. Use of the secure hardware token system enables secure access to websites, e.g., online banking.

The secure hardware token system defends against phishing scams and intrusive spyware tools. In the event a users' PIN is compromised, access continues to be restricted as the offender will not have access to the required digital ID stored on the Digital ID hardware token. The secure hardware token system multiple layers of authentication assure users identity and confidential data remain uncompromised.

The toolkit is generally to integrate with industry standard X.509 digital identities (IDs) through trusted certificate authorities such as GeoTrust, Inc. and VeriSign and provides: a simplified enrollment experience that no longer requires users to manually import digital IDs, strategic solutions based on open standards that leverages existing enterprise applications; and delivers as a managed service to expedite and simplify deployment and administration.

The present digital information protection system: may scale across an organization's network and extend to its partners, business or otherwise; has a simple interface getting users up and running in only a few minutes; and provides strong 2-factor authentication; and can be affordably priced with incredible business and/or organizational value benefits

Institutions may install multiple, single point or limited technical point solutions to address their complex data protection business needs. This approach increases the level of difficulty for administrators to deploy and manage, as well as making it more complicated for customers to use. It is also the most costly approach.

The present system provides a more strategic approach to data protection by leveraging the investment of existing enterprise applications, simplifying the deployment of digital IDs for administrators and users, and providing a clear cost benefit.

Generally the present system may be delivered as a fully-managed security service so that, there are no costly fees for hardware, software or maintenance. The impact on IT staff is generally minimal.

The toolkit uses digital IDs as its basis for enabling strong authentication; strong data integrity; and data encryption for not only files and folders, but for email as well. The toolkit includes four key components (The secure digital ID management utility, the secure email utility, the secure file utility, and the secure hardware token system) which utilize digital IDs to tightly integrate with key enterprise applications such as Microsoft's Windows and Outlook email client or Adobe's Professional document creator. With the toolkit, users require little training for securely using existing applications with which they are already familiar. FIG. 64 shows a relevant diagram of the different elements of the present system.

The toolkit is an effective solution for addressing companies' and organizations' privacy and security compliance initiatives for HIPAA, Sarbanes-Oxley, GLBA and SB1386.

The secure digital ID management utility eases deployment of Digital IDs and digital ID and provides a simple, but powerful, user portal specifically designed to ease the process of obtaining and using X.509 digital IDs (the users' personal digital IDs). The secure digital ID management utility's technological approach allows large enterprises to deploy thousands of digital IDs from trusted certificate authorities (CA), like VeriSign and GeoTrust, with little effort. Users can download and begin using their user's personal digital IDs in 90 seconds or less the user's personal digital IDs provide a strong digital authentication that uniquely identifies users and also acts as the key mechanism for using secure email (The secure email utility) and data encryption (The secure file utility).

The secure email utility enables users to secure their email with ease by automatically configuring Outlook clients. The secure email utility accomplishes this by using end user authentication and encryption standards built into Outlook. Sensitive corporate or personal e-mailed information, including its attachments, will now be secured and protected. The secure email utility addresses the most stringent concerns regarding privacy and security compliance in all business industries, including health (HIPAA) and finance (GLBA, Sarbanes-Oxley, SB1386).

The secure email utility also provides an advanced service that further simplifies the public key lookup and management. For all incoming, digitally signed email, The secure email utility automatically updates and stores the senders' digital ID with Contacts' address book. When using Outlook with Exchange, the public IDs are also stored on the users' Exchange account so they can have secured email with Outlook Web Access (OWA) as well. Once the secure email utility has been installed, Outlook is ready to secure user's confidential email communications, including their attachments.

The secure file utility creates a secure storage zone within the user's computer's hard drive to automatically encrypt sensitive or confidential data. As an extension of Microsoft's Windows Explorer, The secure file utility encrypts and protects data, regardless of the electronic file format. Data stored within The secure file utility is strongly guarded against online hackers and spyware. Even if the computer, laptop or mobile storage media (Floppies, CDs, DVDs, USB hard drives, etc.) are lost or stolen, the confidential information is still protected and cannot be accessed without the user's unique personal digital ID.

To use the secure file utility, the user simply drags-and-drops existing files or entire folders into the secure file area. The user interface mimics the Windows Explorer interface, so there are no new applications to learn. For newly created files, the user can simply save them directly into the secure file utility for assured data protection. Unlike Microsoft's encrypted file system (EFS), the secure file utility doesn't rely upon the Microsoft NTFS file format and users can save their encrypted files onto FAT32 formatted CDs, DVDs, USB hard drives and even floppies.

The secure hardware token system provides two-factor authentication with increased personal digital ID mobility. The secure hardware token systems may be portable USB tokens, smart cards or other devices that add an additional layer of security. The token stores the user's personal digital ID(s) onto the hard tokens for stronger two-factor authentication for all of user's personal digital ID-enabled applications. The user simply inserts the Digital ID hardware token and enters his PIN. The user's credentials will then be accessible to other applications.

As indicated in FIG. 65, the secure hardware token system can be used to strongly' authenticate users for secure email, VPN clients, single sign-on, document signing and encryption, database access and encryption, wireless LANs access, and accessing secure websites. The secure hardware token system can also replace the standard user name and password for Windows logon. The secure hardware token system directly supports the FFIEC's definitive guidance to financial institutions for enabling two-factor authentication to securely access online banking websites by the end of 2006.

Generally, corporations and other organizations need to have a high level of assurance that they are conducting business with partners and clients that have been properly authenticated. Passwords are weak and have been easily compromised on a frequent basis. Certificate Authority programs, such as GeoTrust's True Credentials and VeriSign's digital IDs provide this level of trust. The integration of enrollment digital IDs with the toolkit solves the historical issues associated with issuing, deploying and managing digital IDs.

This unique strategic solution additionally provides an important and distinct capability for digitally signing electronic documents and emails. Documents digitally signed with X.509 digital IDs and the toolkit meet the federal and state requirements of being legally admissible in a court of law.

Medical organizations can benefit from the data security and integrity maintenance system set forth above. Health care organizations have a daunting task of balancing the treatment of patients, legislative compliance, and data protection. Hospitals and clinics must also manage their typical business operations, including finance, procurement, administration, and inventory. To better control the increasing costs of health care operations, medical and related organizations have embraced an eHealth strategy to streamline business processes, improve daily operations, and to reduce operating costs. Secure and trusted communications and information exchange are crucial to achieving privacy assurance.

These are some of the many challenges facing health care organizations in selecting the most effective solutions that are also easy for their physicians and staff to use. Financial budget limitations of such organizations may affect the selection of reasonable security and privacy solution to protect their patients' health information. The technology set forth and disclosed herein meets such criteria of being secure, easy to use, and cost effective. As compared to other security products, the present technology has the distinct capability of digitally signing electronic documents and emails. Documents digitally signed according to the technology set forth herein can support the federal and state requirements for being legally admissible in a court of law. No other technology currently known is believed to provide this level of simplified electronic trust and assurance. The present technology and its use of trusted digital certificates delivers robust data protection when compared to other technologies.

Other systems may be expensive and may not sufficiently authenticate email. Furthermore, such other alternative technologies may not meet the requirements for providing legally binding digital signatures. The disadvantages of other technologies may include the increased use or need of training, the requirements of additional investment in server hardware and software, the requirements of additional system, administrator, and/or related resources, as well as the training that is usually required and provided by a third party for additional fees.

The present technology with its secure information toolkit and components manages the required electronic information managed trust service and may provide an unlimited ability for software replication. Additionally, strong email authentication is provided as well as strong 2-factor authentication, especially with the secure hardware token system set forth herein. The present technology meets federal and state requirements for legally binding digital signatures and no additional server hardware demands or required. Consequently, the present technology may have a minimal impact on IT staff as well as a reduced or minimized on site training requirement.

The digital information protection system set forth herein may leverage existing enterprise applications and infrastructure and may simplify user training requirements. The present technology may be easily adaptable to new enterprise applications and enable the conclusion of new types of digital certificate capabilities and/or later releases.

Consumer confidence in financial institutions for protecting their assets and their personal identities has decidedly eroded as a direct result of the significant number of successful increases of Internet security and privacy incidents. To better control the increasing costs of business operations, many institutions have implemented an eFinance strategy that streamlines their business processes, improves operations and reduces operating costs. Businesses and customers who rely upon the Internet for confidential online services may demand secure communications and information exchange for assurances of trust and privacy. Customers will not continue to put their funds and identities at risk if they do not trust the institutions who are supposed to be protecting their interests.

These and other challenges face financial organizations in selecting the most effective solutions that are also easy for their staff to use. Also, there are the financial budget limitations of these organizations for selecting reasonable security and privacy solutions to protect private and confidential information. The toolkit solution set disclosed herein meets the criteria of being secure, easy to use and cost-effective. As compared to other competing security products, the toolkit also provides an important and distinct capability of digitally signing electronic documents and emails. Documents digitally signed with the toolkit meet the federal and state requirements for being legally admissible in a court of law. No other solution provides this level of simplified electronic trust and assurance.

The toolkit and its use of trusted digital certificates deliver robust data protection as compared to other systems. The toolkit system provided herein impacts and helps resolve security issues in a variety of areas, including: business requirements; meeting the security compliance demands of GLBA, Sarbanes-Oxley & SB 1386; protecting consumers' privacy and online identities; delivering on eFinance initiatives; eBanking, eBrokerages, eMortgages, ePayments, elnsurance, eContracts, significantly reducing paper-based transactions; streamlining complex business processes; data protection capabilities matrix, and True Cost of Ownership. Furthermore, the security toolkit provided herein enables: simply deployment; possibly unlimited software replication; strong 2-factor authentication (Windows, websites, VPNs, . . . ); and strong email authentication.

Further, the toolkit meets Federal and State Requirements for legally binding digital signatures, has no server hardware demands (zero datacenter footprint), and has minimal impact on IT Staff. The toolkit is based on the X.509 open standard for PKI to ensure interoperability of existing and future enterprise applications. The toolkit: leverages existing enterprise applications and infrastructure; simplifies user training requirements; provides a clear return on investment and future cost savings; may include new applications with digital certificate capabilities in latest releases; has fast implementation times (days, not months); is cost-effective with few, if any, hidden costs; and imposes no server hardware demands (zero footprint). The toolkit uniquely provides trusted digital information as well as robust data protection, strong email authentication (anti-spoofing, anti-spam and anti-phishing) and provides legally binding, digital signatures.

Corporate and personal information is increasingly at risk. Vast amounts of financial, health and intellectual property information are stored on computing devices as well as being transmitted over the Internet. Privacy and security breaches that improperly expose these types of sensitive and confidential information can result in a compliance and public relations dilemma. The present system delivers data protection solutions that help enterprises and individuals protect their most valuable digital assets.

The security toolkit provides data assurance for confidential information. By leveraging existing business applications, the toolkit provides an additional level of protection that is simple to use, very secure and affordable. Partnering with leading global managed digital certificate providers such as VeriSign and GeoTrust, the secure service solutions of the toolkit offer significant cost reduction for deploying and managing trusted digital certificates.

The present invention provides secure access and limits availability to files, e-mail and other messages, and file/network resources by means of digital certificates (herein denominated (personal digital IDs). The present invention also provides such securement of digital information in an easy and as transparent as possible manner.

While the present invention has been described with regards to particular embodiments, it is recognized that additional variations of the present invention may be devised without departing from the inventive concept. For example, while the methods and solutions described herein may be easily adapted to current electronic information technology, those technologies now known or developed in the future may also advantageously apply the information protection system described herein, including optical technologies, possibly acoustic technologies, or otherwise.

What is claimed is:

1. A method for protecting integrity and secrecy of digital information, the steps comprising:
providing an ID interface for obtaining and managing a personal digital ID;
providing an email utility interface having access to said personal digital ID, said email utility interface automatically configuring and associating said personal digital ID with an email program, said email utility interface adapted to receive a public key from a sender and associate said public key with a contact entry for said sender, said email utility interface adapted to facilitate sending of email with a signature derived from said personal digital ID;
providing a secure file area interface based upon said personal digital ID wherein when a file is dragged and dropped into said secure file area interface, said file is encrypted with said personal digital ID to provide an encrypted file; and
providing a hardware token system securely storing said personal digital ID to provide authentication; whereby
digital information may be secured with said personal digital ID including emails and digital files.

2. A method for protecting integrity and secrecy of digital information as set forth in claim 1, wherein said step of providing an ID interface for obtaining and managing a personal digital ID further comprises:
providing an enrollment procedure for obtaining said personal digital ID;
storing said personal digital ID in a secure certificate store; and
making said personal digital ID available to said email utility and said secure file area interface.

3. A method for protecting integrity and secrecy of digital information as set forth in claim 1, wherein said step of providing an ID interface for obtaining and managing a personal digital ID further comprises:
providing an ID interface adapted to obtain and manage a plurality of personal digital IDs; and
said ID interface enabling selection of an individual one of said plurality of personal digital IDs.

4. A method for protecting integrity and secrecy of digital information as set forth in claim 1, wherein said step of providing an ID interface for obtaining and managing a personal digital ID further comprises:
providing an ID interface adapted to receive a password to protect activities associated with said personal digital ID.

5. A method for protecting integrity and secrecy of digital information as set forth in claim 4, wherein said activities associated with said personal digital ID further comprise:
activities selected from the group consisting of access to said ID interface, access to said filed secured by said secure file area interface, and combinations thereof.

6. A method for protecting integrity and secrecy of digital information as set forth in claim 1, wherein said step of providing an ID interface for obtaining and managing a personal digital ID further comprises:
providing an ID interface that records use of said personal digital ID for future review.

7. A method for protecting integrity and secrecy of digital information as set forth in claim 6, wherein said step of providing an ID interface for obtaining and managing a personal digital ID further comprises:
providing an ID interface that manages expired personal digital IDs.

8. A method for protecting integrity and secrecy of digital information as set forth in claim 1, further comprising:
said email utility interface automatically administrates association of said personal digital ID with an email client and relieves a user of manually re-configuring said email client for secure email in association with said personal digital ID.

9. A method for protecting integrity and secrecy of digital information as set forth in claim 1, further comprising:
said email utility interface selectively enables sending of clear text signed messages when sending signed messages.

10. A method for protecting integrity and secrecy of digital information as set forth in claim 1, further comprising:
said email utility interface selectively enables SHA-1 as a hash algorithm.

11. A method for protecting integrity and secrecy of digital information as set forth in claim 1, further comprising:
said email utility interface selectively enables 3DES as an encryption algorithm.

12. A method for protecting integrity and secrecy of digital information as set forth in claim 1, further comprising:
said email utility interface selectively enables sending said personal digital ID with signed messages.

13. A method for protecting integrity and secrecy of digital information as set forth in claim 1, further comprising:
said email utility interface automatically updating a digital certificate of a signed email sender for whom a contact entry already exists.

14. A method for protecting integrity and secrecy of digital information as set forth in claim 1, further comprising:
said email utility interface automatically populating a toolbar of said email program with a first icon enabling signing of an email with a signature derived from said personal digital ID and with a second icon enabling encryption of said email in a manner derived from said personal digital ID.

15. A method for protecting integrity and secrecy of digital information as set forth in claim 1, further comprising:
said secure file area interface disallowing copy actions for said file into said secure file area interface and only allowing moving actions for said file into said secure file area interface.

16. A method for protecting integrity and secrecy of digital information as set forth in claim 1, further comprising:
said secure file area interface maintaining original directory structure for said file.

17. A method for protecting integrity and secrecy of digital information as set forth in claim 16, further comprising:
said maintaining of said original directory structure for said file including maintaining of last modified date information associated with said file wherein said last modified date information is not overwritten when said file is moved into said secure file area interface and said file is encrypted.

18. A method for protecting integrity and secrecy of digital information as set forth in claim 1, further comprising:
said secure file area interface enabling file operations upon said file, said file operations selected from the group consisting of deletion, renaming, copying, moving, and combinations thereof within said secure file area interface.

19. A method for protecting integrity and secrecy of digital information as set forth in claim 1, further comprising:
said secure file area interface enabling opening of said file from within said secure file area interface, said secure file area interface decrypting said file and enabling loading of said file into an associated application.

20. A method for protecting integrity and secrecy of digital information as set forth in claim 19, further comprising:
said file being editable and savable in said associated application, said secure file area interface re-encrypting said file upon closure of said file in said associated application.

21. A method for protecting integrity and secrecy of digital information as set forth in claim 1, further comprising:
said secure file area interface encrypting a folder placed in said secure file area interface.

22. A method for protecting integrity and secrecy of digital information as set forth in claim 1, further comprising:
said secure file area interface tagging said file with an identifier in a filename of said file with an extension of said filename remaining the same to retain an icon associated with said file for display purposes.

23. A method for protecting integrity and secrecy of digital information as set forth in claim 1, further comprising:
said secure file area interface enabling encryption of a second file outside said secure file area interface.

24. A method for protecting integrity and secrecy of digital information as set forth in claim 23, further comprising:
said encryption of said second file invoked by right-clicking or invoking a metatask upon said second file.

25. A method for protecting integrity and secrecy of digital information as set forth in claim 1, further comprising:
protecting access to said secure file area interface with a password.

26. A method for protecting integrity and secrecy of digital information as set forth in claim 1, further comprising:
said encrypted file being transportable or copyable to a storage medium, said encrypted file remaining secure although it is outside said secure file area interface.

27. A method for protecting integrity and secrecy of digital information as set forth in claim 1, further comprising:
said hardware token system having a hardware token selected from the group consisting of USB tokens, smart cards, writeable memory medias, and combinations thereof.

28. A method for protecting integrity and secrecy of digital information as set forth in claim 1, further comprising:
said hardware token system requiring an inputting of a PIN to enable access to a computer asset.

29. A method for protecting integrity and secrecy of digital information as set forth in claim 28, further comprising:
said computer asset selected from the group consisting of computers, networks, computer applications, and combinations thereof.

30. A method for protecting integrity and secrecy of digital information as set forth in claim 1, further comprising:
said hardware token system operating to replace actions selected from the group consisting of logging onto an operating system, logging off an operating system session, locking an operating system session, shutting down a computer, and combinations thereof.

31. A method for protecting integrity and secrecy of digital information as set forth in claim 30, further comprising:
said operating system being Microsoft Windows.

32. A method for protecting integrity and secrecy of digital information as set forth in claim 30, further comprising:
said hardware token system requiring a PIN to enable said actions.

33. A method for protecting integrity and secrecy of digital information as set forth in claim 1, further comprising:
said hardware token system making available said personal digital ID for securing an email message including signing and encrypting said email message.

34. A method for protecting integrity and secrecy of digital information as set forth in claim 1, further comprising:
said hardware token system making available said personal digital ID for securing said file in said secure file area interface.

35. A method for protecting integrity and secrecy of digital information, the steps comprising:
providing an ID interface for obtaining and managing a personal digital ID;
providing an email utility interface having access to said personal digital ID, said email utility interface automatically configuring and associating said personal digital ID with an email program, said email utility interface adapted to receive a public key from a sender and associate said public key with a contact entry for said sender, said email utility interface adapted to facilitate sending of email with a signature derived from said personal digital ID;
providing a secure file area interface based upon said personal digital ID wherein when a file is dragged and dropped into said secure file area interface, said file is encrypted with said personal digital ID to provide an encrypted file;
providing a hardware token system securely storing said personal digital ID to provide authentication such that digital information may be secured with said personal digital ID including emails and digital files;
said ID interface providing an-enrollment procedure for obtaining said personal digital ID and storing said personal digital ID in a secure certificate store;
said ID interface making said personal digital ID available to said email utility and said secure file area interface and adapted to obtain and manage a plurality of personal digital IDs and enabling selection of an individual one of said plurality of personal digital IDs;
said ID interface adapted to receive a first password to protect activities associated with said personal digital ID, said activities including access to said ID interface, access to said file secured by said secure file area interface, and combinations thereof;
said ID interface recording use of said personal digital ID for future review and managing expired personal digital IDs;
said email utility interface automatically administrating association of said personal digital ID with an email client and relieving a user of manually re-configuring said email client for secure email in association with said personal digital ID;
said email utility interface selectively enabling sending of clear text signed messages when sending signed messages, selectively enabling SHA-1 as a hash algorithm, and selectively enabling 3DES as an encryption algorithm;
said email utility interface selectively enabling sending said personal digital ID with signed messages;
said email utility interface automatically updating a digital certificate of a signed email sender for whom a contact entry already exists and automatically populating a toolbar of said email program with a first icon enabling signing of an email with a signature derived from said personal digital ID and with a second icon enabling encryption of said email in a manner derived from said personal digital ID;
said secure file area interface disallowing copy actions for said file into said secure file area interface and only allowing moving actions for said file into said secure file area interface;
said secure file area interface maintaining original directory structure for said file, said maintaining of said original directory structure for said file including maintaining of last modified date information associated with said file wherein said last modified date information is not overwritten when said file is moved into said secure file area interface and said file is encrypted;
said secure file area interface enabling file operations upon said file, said file operations including deletion, renaming, copying, moving, and combinations thereof within said secure file area interface;
said secure file area interface enabling opening of said file from within said secure file area interface, said secure file area interface decrypting said file and enabling loading of said file into an associated application;
said file being editable and savable in said associated application, said secure file area interface re-encrypting said file upon closure of said file in said associated application;
said secure file area interface adapted to encrypt a folder placed in said secure file area interface;
said secure file area interface tagging said file with an identifier in a filename of said file with an extension of said filename remaining the same to retain an icon associated with said file for display purposes;
said secure file area interface enabling encryption of a second file outside said secure file area interface, said encryption of said second file invoked by right-clicking or invoking a metatask upon said second file;
protecting access to said secure file area interface with a password;
said encrypted file being transportable or copyable to a storage medium, said encrypted file remaining secure although it is outside the secure file area interface;
said hardware token system having a hardware token, said hardware token selected from a group of hardware tokens including USB tokens, smart cards, writeable memory medias, and combinations thereof;
said hardware token system requiring an inputting of a PIN to enable access to a computer asset;
said computer asset including computers, networks, computer applications, and combinations thereof;
said hardware token system operating to replace actions including logging onto an operating system, logging off an operating system session, locking an operating system session, shutting down a computer, and combinations thereof;
said hardware token system requiring a PIN to enable said actions;
said hardware token system making available said personal digital ID for securing an email message including signing and encrypting said email message; and
said hardware token system making available said personal digital ID for securing said file in said secure file area interface.

36. A method for protecting integrity and secrecy of digital information, the steps comprising:
providing an ID interface for obtaining and managing a personal digital ID, said ID interface providing an enrollment procedure for obtaining said personal digital ID, storing said personal digital ID in a secure certificate store, and making said personal digital ID available to an email utility and a secure file area interface.

37. A method for protecting integrity and secrecy of digital information as set forth in claim 36, wherein said step of providing an ID interface for obtaining and managing a personal digital ID further comprises:
providing an ID interface adapted to obtain and manage a plurality of personal digital IDs; and
said ID interface enabling selection of an individual one of said plurality of personal digital IDs.

38. A method for protecting integrity and secrecy of digital information as set forth in claim 36, wherein said step of providing an ID interface for obtaining and managing a personal digital ID further comprises:
providing an ID interface adapted to receive a password to protect activities associated with said personal digital ID.

39. A method for protecting integrity and secrecy of digital information as set forth in claim 38, wherein said activities associated with said personal digital ID further comprise:
activities selected from the group consisting of access to said ID interface, access to said filed secured by said secure file area interface, and combinations thereof.

40. A method for protecting integrity and secrecy of digital information as set forth in claim 36, wherein said step of providing an ID interface for obtaining and managing a personal digital ID further comprises:
providing an ID interface that records use of said personal digital ID for future review.

41. A method for protecting integrity and secrecy of digital information as set forth in claim 40, wherein said step of providing an ID interface for obtaining and managing a personal digital ID further comprises:
providing an ID interface that manages expired personal digital IDs.

42. A method for protecting integrity and secrecy of digital information, the steps comprising:
providing an ID interface for obtaining and managing a personal digital ID, said ID interface providing an enrollment procedure for obtaining said personal digital ID, storing said personal digital ID in a secure certificate store, and making said personal digital ID available to an email utility and a secure file area interface;
said ID interface adapted to obtain and manage a plurality of personal digital IDs and enabling selection of an individual one of said plurality of personal digital IDs;
said ID interface adapted to receive a password to protect activities associated with said personal digital ID, said activities selected from the group consisting of access to said ID interface, access to said filed secured by said secure file area interface, and combinations thereof; and
said ID interface that recording use of said personal digital ID for future review and managing expired personal digital IDs.

43. A method for protecting integrity and secrecy of digital information, the steps comprising:
providing an email utility interface having access to a personal digital ID, said email utility interface automatically configuring and associating said personal digital ID with an email program, said email utility interface adapted to receive a public key from a sender and associate said public key with a contact entry for said sender, said email utility interface adapted to facilitate sending of email with a signature derived from said personal digital ID.

44. A method for protecting integrity and secrecy of digital information as set forth in claim 43, further comprising:
said email utility interface automatically administrates association of said personal digital ID with an email client and relieves a user of manually re-configuring said email client for secure email in association with said personal digital ID.

45. A method for protecting integrity and secrecy of digital information as set forth in claim 43, further comprising:
said email utility interface selectively enables sending of clear text signed messages when sending signed messages.

46. A method for protecting integrity and secrecy of digital information as set forth in claim 43, further comprising:
said email utility interface selectively enables SHA-1 as a hash algorithm.

47. A method for protecting integrity and secrecy of digital information as set forth in claim 43, further comprising:
said email utility interface selectively enables 3DES as an encryption algorithm.

48. A method for protecting integrity and secrecy of digital information as set forth in claim 43, further comprising:
said email utility interface selectively enables sending said personal digital ID with signed messages.

49. A method for protecting integrity and secrecy of digital information as set forth in claim 43, further comprising:
said email utility interface automatically updating a digital certificate of a signed email sender for whom a contact entry already exists.

50. A method for protecting integrity and secrecy of digital information as set forth in claim 43, further comprising:
said email utility interface automatically populating a toolbar of said email program with a first icon enabling signing of an email with a signature derived from said personal digital ID and with a second icon enabling encryption of said email in a manner derived from said personal digital ID.

51. A method for protecting integrity and secrecy of digital information, the steps comprising:
providing an email utility interface having access to a personal digital ID, said email utility interface automatically configuring and associating said personal digital ID with an email program, said email utility interface adapted to receive a public key from a sender and associate said public key with a contact entry for said sender, said email utility interface adapted to facilitate sending of email with a signature derived from said personal digital ID;
said email utility interface automatically administrates association of said personal digital ID with an email client and relieves a user of manually re-configuring said email client for secure email in association with said personal digital ID;
said email utility interface selectively enabling sending of clear text signed messages when sending signed messages;
said email utility interface selectively enabling SHA-1 as a hash algorithm;
said email utility interface selectively enabling 3DES as an encryption algorithm;
said email utility interface selectively enabling sending said personal digital ID with signed messages;
said email utility interface automatically updating a digital certificate of a signed email sender for whom a contact entry already exists; and
said email utility interface automatically populating a toolbar of said email program with a first icon enabling signing of an email with a signature derived from said personal digital ID and with a second icon enabling encryption of said email in a manner derived from said personal digital ID.

52. A method for protecting integrity and secrecy of digital information, the steps comprising:
providing a secure file area interface based upon said personal digital ID wherein when a file is dragged and dropped into said secure file area interface, said file is encrypted with said personal digital ID to provide an encrypted file.

53. A method for protecting integrity and secrecy of digital information as set forth in claim 52, further comprising:
said secure file area interface disallowing copy actions for said file into said secure file area interface and only allowing moving actions for said file into said secure file area interface.

54. A method for protecting integrity and secrecy of digital information as set forth in claim 52, further comprising:
said secure file area interface maintaining original directory structure for said file.

55. A method for protecting integrity and secrecy of digital information as set forth in claim 54, further comprising:
said maintaining of said original directory structure for said file including maintaining of last modified date information associated with said file wherein said last modified date information is not overwritten when said file is moved into said secure file area interface and said file is encrypted.

56. A method for protecting integrity and secrecy of digital information as set forth in claim 52, further comprising:
said secure file area interface enabling file operations upon said file, said file operations selected from the group consisting of deletion, renaming, copying, moving, and combinations thereof within said secure file area interface.

57. A method for protecting integrity and secrecy of digital information as set forth in claim 52, further comprising:
said secure file area interface enabling opening of said file from within said secure file area interface, said secure file area interface decrypting said file and enabling loading of said file into an associated application.

58. A method for protecting integrity and secrecy of digital information as set forth in claim 57, further comprising:
said file being editable and savable in said associated application, said secure file area interface re-encrypting said file upon closure of said file in said associated application.

59. A method for protecting integrity and secrecy of digital information as set forth in claim 52, further comprising:
said secure file area interface encrypting a folder placed in said secure file area interface.

60. A method for protecting integrity and secrecy of digital information as set forth in claim 52, further comprising:
said secure file area interface tagging said file with an identifier in a filename of said file with an extension of said filename remaining the same to retain an icon associated with said file for display purposes.

61. A method for protecting integrity and secrecy of digital information as set forth in claim 52, further comprising:
said secure file area interface enabling encryption of a second file outside said secure file area interface.

62. A method for protecting integrity and secrecy of digital information as set forth in claim 61, further comprising:
said encryption of said second file invoked by right-clicking or invoking a metatask upon said second file.

63. A method for protecting integrity and secrecy of digital information as set forth in claim 52, further comprising:
protecting access to said secure file area interface with a password.

64. A method for protecting integrity and secrecy of digital information as set forth in claim 52, further comprising:
said encrypted file being transportable or copyable to a storage medium, said encrypted file remaining secure although it is outside the secure file area interface.

65. A method for protecting integrity and secrecy of digital information, the steps comprising:
providing a secure file area interface based upon said personal digital ID wherein when a file is dragged and dropped into said secure file area interface, said file is encrypted with said personal digital ID to provide an encrypted file;
said secure file area interface disallowing copy actions for said file into said secure file area interface and only allowing moving actions for said file into said secure file area interface;
said secure file area interface maintaining original directory structure for said file, said maintaining of said original directory structure for said file including maintaining of last modified date information associated with said file wherein said last modified date information is not overwritten when said file is moved into said secure file area interface and said file is encrypted;
said secure file area interface enabling file operations upon said file, said file operations selected from the group consisting of deletion, renaming, copying, moving, and combinations thereof within said secure file area interface;
said secure file area interface enabling opening of said file from within said secure file area interface, said secure file area interface decrypting said file and enabling loading of said file into an associated application, said file being editable and savable in said associated application, said secure file area interface re-encrypting said file upon closure of said file in said associated application;
said secure file area interface adapted to encrypt a folder placed in said secure file area interface;
said secure file area interface tagging said file with an identifier in a filename of said file with an extension of said filename remaining the same to retain an icon associated with said file for display purposes;
protecting access to said secure file area interface with a password; and
said secure file area interface enabling encryption of a second file outside said secure file area interface, said encryption of said second file invoked by right-clicking or invoking a metatask upon said second file, said encrypted file being transportable or copyable to a storage medium, said encrypted file remaining secure although it is outside the secure file area interface.

66. A method for protecting integrity and secrecy of digital information, the steps comprising:
providing a hardware token system securely storing said personal digital ID to provide authentication.

67. A method for protecting integrity and secrecy of digital information as set forth in claim 66, further comprising:
said hardware token system having a hardware token selected from the group consisting of USB tokens, smart cards, writeable memory medias, and combinations thereof.

68. A method for protecting integrity and secrecy of digital information as set forth in claim 66, further comprising:
said hardware token system requiring an inputting of a PIN to enable access to a computer asset.

69. A method for protecting integrity and secrecy of digital information as set forth in claim 68, further comprising:
said computer asset selected from the group consisting of computers, networks, computer applications, and combinations thereof.

70. A method for protecting integrity and secrecy of digital information as set forth in claim 66, further comprising:
said hardware token system operating to replace actions selected from the group consisting of logging onto an operating system, logging off an operating system session, locking an operating system session, shutting down a computer, and combinations thereof.

71. A method for protecting integrity and secrecy of digital information as set forth in claim 70, further comprising:
said operating system being Microsoft Windows.

72. A method for protecting integrity and secrecy of digital information as set forth in claim 70, further comprising:
said hardware token system requiring a PIN to enable said actions.

73. A method for protecting integrity and secrecy of digital information as set forth in claim 66, further comprising:
said hardware token system making available said personal digital ID for securing an email message including signing and encrypting said email message.

74. A method for protecting integrity and secrecy of digital information as set forth in claim 66, further comprising:
said hardware token system making available said personal digital ID for securing said file in a secure file area interface.

75. A method for protecting integrity and secrecy of digital information, the steps comprising:
providing a hardware token system securely storing said personal digital ID to provide authentication such that digital information may be secured with said personal digital ID including emails and digital files;
said hardware token system having a hardware token, said hardware token selected from a group of hardware tokens including USB tokens, smart cards, writeable memory medias, and combinations thereof;
said hardware token system requiring an inputting of a PIN to enable access to a computer asset;
said computer asset including computers, networks, computer applications, and combinations thereof;
said hardware token system operating to replace actions including logging onto an operating system, logging off an operating system session, locking an operating system session, shutting down a computer, and combinations thereof;
said hardware token system requiring a PIN to enable said actions;
said hardware token system making available said personal digital ID for securing an email message including signing and encrypting said email message; and
said hardware token system making available said personal digital ID for securing said file in a secure file area interface.
